(19) United States
(12) Patent Application Publication
(10) Pub. No.: US 2025/0274167 A1
(43) Pub. Date: Aug. 28, 2025

(54) METHOD AND APPARATUS FOR CHANNEL ESTIMATION FOR MIMO SYSTEMS

(71) Applicant: Huawei Technologies Co., Ltd., Shenzhen (CN)

(72) Inventors: Wuxian Shi, Kanata (CA); Yiqun Ge, Ottawa (CA); Wen Tong, Ottawa (CA); Jianglei Ma, Ottawa (CA)

(21) Appl. No.: 19/187,689

(22) Filed: Apr. 23, 2025

Related U.S. Application Data
(63) Continuation of application No. PCT/CN2022/126878, filed on Oct. 24, 2022.

(51) Int. Cl. H04B 7/0413; H04L 5/00; H04L 25/02

(52) U.S. Cl. CPC H04B 7/0413; H04L 5/0023; H04L 5/0098; H04L 25/0202

(57) ABSTRACT

A method of MIMO channel estimation is provided that involves the transmission of MIMO reference signals that use a non-uniform pattern of resources in space, time, frequency, and/or code and is calculated from a prior knowledge. The prior knowledge is obtained from a plurality of MIMO channel samples associated to a region. In a receiver, MIMO reference signal are received based on a receiver-MIMO-reference-signal-placement is also a non-uniform pattern of resources in space, time, frequency, and/or code and is calculated from the prior knowledge. A MIMO channel is estimated from channel measurement on the reference signals and the prior knowledge.

### CROSS-REFERENCE TO RELATED APPLICATIONS

The application is a continuation of International Application No. PCT/CN2022/126878, filed on Oct. 24, 2022, the disclosure of which is hereby incorporated by reference in its entirety.

### TECHNICAL FIELD

The application relates generally to wireless communications, and more specifically to channel estimation and feedback for multiple-input multiple-output (MIMO) systems.

### BACKGROUND

In a wireless communication system, it is important to estimate a channel. To estimate a channel, reference signals must be known to both transmitter device and receiver device before transmission is started. A receiver device estimates channel by receiving and measuring reference signals sent by transmitter device.

Before a MIMO transmission is started between a base station (BS) and a user equipment (UE) or UEs, reference signals in MIMO channel space should be arranged. In orthogonal frequency division multiplexing (OFDM) mode, MIMO channel on each subcarrier is represented by an N-by-M complex matrix where M is number of transmitter antennas and Nis number of receiver antennas. Over the L subcarriers, this MIMO channel forms a 3-D channel space: L-by-N-by-M where L is the number of subcarriers.

In 5G, reference signals are referred as channel state indication—reference signal (CSI-RS) (for downlink) and sounding reference signal (SRS) (for uplink). Downlink reference signals are usually transmitted in a multicast or broadcast mode, while uplink reference signals are usually transmitted in a unicast mode. Reference signals in 5G MIMO channel space are uniformly distributed across radio resources with a density pre-defined in the specification.

In 6G, the numbers of subcarriers, transmitter antennas, and receiver antennas, would dramatically increase. 6G MIMO channel space may use up to 500 MHz bandwidth with 15 kHz subcarrier spacing, resulting in 33,333 subcarriers or 2,777 resource blocks (RB). The number of BS antennas could reach 1024 and number of UE antennas could reach 32. Even though only one reference signal is transmitted per RB per transmit time interval (TTI), the total number of reference signals would reach 2,777*1,024*32=90,996,736 per TTI, resulting into a much heavy overhead in measuring and feedbacking channel measurements.

### SUMMARY

A method of MIMO channel estimation is provided that involves the transmission of MIMO reference signals that use a non-uniform pattern of resources in space, time, frequency, and/or code and is calculated from a prior knowledge. The prior knowledge is obtained from a plurality of MIMO channel samples associated to a region. In a receiver, MIMO reference signal are received based on a receiver-MIMO-reference-signal-placement is also a non-uniform pattern of resources in space, time, frequency, and/or code and is calculated from the prior knowledge. A MIMO channel is estimated from channel measurement on the reference signals and the prior knowledge. Overhead in measuring and feedbacking channel measurements can be reduced by using the method.

According to one aspect of the present disclosure, there is provided a method of MIMO channel estimation comprising: transmitting, by a transmitter device, multiple input multiple output (MIMO) reference signals using a transmission-MIMO-reference-signal-pattern, wherein the transmission-MIMO-reference-signal-pattern contains a transmission-MIMO-reference-signal-placement; wherein the transmission-MIMO-reference-signal-placement is a non-uniform pattern of resources in space, time, frequency, and/or code and is calculated from a prior knowledge; wherein the prior knowledge is obtained from a plurality of MIMO channel samples associated to a region; receiving, by a receiver device, MIMO reference signals using a receiver-MIMO-reference-signal-pattern; wherein the receiver-MIMO-reference-signal-pattern contains a receiver-MIMO-reference-signal-placement; wherein the receiver-MIMO-reference-signal-placement is a non-uniform pattern of resources in space, time, frequency, and/or code and is calculated from the prior knowledge, wherein the prior knowledge is obtained from a plurality of MIMO channel samples associated to the region; estimating, by the receiver device, MIMO channel from channel measurement on the reference signals and the prior knowledge.

In some embodiments, the method further comprises, after receiving, by a receiver device, MIMO reference signals: transmitting, by the receiver device, feedback based on channel measurement on the reference signals; receiving, by the transmitter device, feedback based on channel measurement on the reference signals; estimating, by the transmitter device, MIMO channel from the feedback.

In some embodiments, the prior knowledge is represented by a channel space basis matrix U; wherein the channel space basis matrix U consists of a plurality of orthonormal channel basis vectors and is obtained from a plurality of MIMO channel samples vectorized from a multiple-dimensional MIMO channel form including space, time, frequency, and/or code.

In some embodiments, the prior knowledge represented by a channel space basis matrix U is associated to a region, and different prior knowledges represented by different channel space basis matrixes U associated to different regions.

In some embodiments, a plurality of MIMO channel samples for each of a plurality of different regions are reshaped, and arranged into a channel training matrix A composed of vectorized MIMO channel samples of length n: the channel space basis matrix U based on a rank-reduced truncated singular value decomposition (SVD) of channel training matrix A according to: SVD (A)=UΣV^{H} where the SVD on the training matrix A is truncated by keeping the largest r singular values, wherein r is a defined rank, and the channel space basis matrix U has size n-by-r.

In some embodiments, the method, before transmitting multiple input multiple output (MIMO) reference signals using a transmission-MIMO-reference-signal-pattern, further comprises, obtaining, by the transmitter device, a region to which the transmitter device and receiver device belong, the prior knowledge represented by a channel space basis matrix U associated to the region, and a transmission-MIMO-reference-signal-pattern.

In some embodiments, the transmission-MIMO-reference-signal-pattern contains: a transmission-MIMO-reference-signal-placement including reference signal positions, each of which indicates on which subcarrier and on which transmitter antennas in a MIMO channel space a reference signal to be transmitted; transmitted signal value for each reference signal; or multiplexing scheme for each reference signal.

In some embodiments, the method, before using a transmission-MIMO-reference-signal-pattern, further comprises: obtaining, by the transmitter device, a transmission-MIMO-reference-signal-placement and transmission-placement-to-pattern-generation method.

In some embodiments, the method, before using a transmission-MIMO-reference-signal-placement, further comprises: obtaining, by the transmitter device, a basic-MIMO-reference-signal-placement and basic-to-transmission- placement-generation method.

In some embodiments, the method before receiving multiple input multiple output (MIMO) reference signals using a receiver-MIMO-reference-signal-pattern, further comprises: obtaining, by the receiver device, a region to which the transmitter device and receiver device belong, the prior knowledge represented by a channel space basis matrix U associated to the region, and a receiver-MIMO-reference-signal-pattern.

In some embodiments, the receiver-MIMO-reference-signal-pattern contains: a receiver-MIMO-reference-signal-placement includes reference signal positions, each of which indicates on which subcarrier, on which transmitter antenna, and on which receiver antennas in a MIMO channel space a reference signal to be transmitted; transmitted signal value for each reference signal; or (de)multiplexing scheme for each reference signal.

In some embodiments, the method before using a receiver-MIMO-reference-signal-pattern, further comprise: obtaining, by the receiver device, a receiver-MIMO-reference-signal-placement and receiver-placement-to-pattern-generation method.

In some embodiments, the method before using a transmission-MIMO-reference-signal-placement, further comprises: obtaining, by the receiver device, a basic-MIMO-reference-signal-placement and basic-to-receiver-placement-generation method; and/or obtaining, by the receiver device, a transmission-MIMO-reference-signal-placement and transmission-to-receiver-placement-generation method.

In some embodiments, r pivot positions obtained from the channel space basis matrix U^{H}, the r pivot positions corresponding to the basic-MIMO-reference-signal-placement, each defining a reference signal position in a MIMO channel space by a subcarrier, a transmitter antenna, and a receiver antenna, where U^{H} is the Hermitian transpose of U; wherein a MIMO channel space includes the number of subcarriers, number of transmitter antennas, and number of receiver antennas.

In some embodiments, transmission-placement-to-pattern-generation method specifies transmitted signal value and multiplexing scheme for each reference signal in transmission-MIMO-reference-signal-placement; wherein the multiplexing scheme includes time-multiplexing, frequency-multiplexing, and/or code-multiplexing.

In some embodiments, receiver-placement-to-pattern-generation method specifies transmitted signal value and (de)-multiplexing scheme for each reference signal in receiver-MIMO-reference-signal-placement; wherein the (de)-multiplexing scheme includes time-(de)-multiplexing, frequency-(de)-multiplexing, and/or code-(de)-multiplexing.

In some embodiments, basic-to-transmission-placement-generation method merge any two reference signal positions in a basic-MIMO-reference-signal-placement that share the same subcarrier and the same transmitter antenna but has different receiver antennas one reference-signal position in the transmission-MIMO-reference-signal-placement.

In some embodiments, basic-to-receiver-placement-generation method includes a basic part and may include an augmentation part into a receiver-MIMO-reference-signal-placement from a basic-MIMO-reference-signal-placement; or transmission-to-receiver-placement-generation method includes a basic part and include an augmentation part into a receiver-MIMO-reference-signal-placement from a transmission-MIMO-reference-signal-placement.

In some embodiments, the basic part includes reference signal positions in a basic-MIMO-reference-signal-placement and the augmentation part includes a plurality of reference signal positions that share the same subcarrier and the same transmitter antenna but have different receiver antennas and not in the basic-MIMO-reference-signal-placement.

In some embodiments, the augmentation part is changed and updated.

In some embodiments, the method after receiving multiple input multiple output (MIMO) reference signals using a receiver-MIMO-reference-signal-pattern and before estimating, by the receiver device, MIMO channel from channel measurement on the reference signals and the prior knowledge, further comprising: measuring, by the receiver device, channel on the reference signal positions indicated by the receiver-MIMO-reference-signal-pattern into a vector y.

In some embodiments, MIMO channel estimation from channel measurement on the reference signals and the prior knowledge, wherein channel measurement on the reference signals represented in a vector y and prior knowledge represented by channel space basis matrix U, needs a compact channel basis θ_{aug} and its left inverse are defined as follows:

$$\begin{matrix}{θ}_{aug} = {P}_{Rx}^{*} U \\ {θ}_{aug}^{- 1} = {( {θ}_{aug}^{H} * {θ}_{aug} )}^{- 1 *} {θ}_{aug}^{H}\end{matrix}$$

where P_{Rx} is a placement matrix determined by the receiver-MIMO-reference-signal-placement, and a vector a of coefficients determined according to:

$$a = {θ}_{aug}^{- 1} * y$$

MIMO channel ĥ is estimated according to:

$$\hat{h} = U * a .$$

In some embodiments, in a case where a subset of MIMO channel ĥ′ needs to be estimated, according to:

$${\hat{h}}^{′} = {U}^{′} * a$$

where U′ is a subset of channel space basis matrix U.

In some embodiments, in a case where only a subset of a vector a of coefficients is available, MIMO channel ĥ is estimated according to:

$$\hat{h} = U * {a}^{′} ;$$

where a′ is a subset of a vector coefficients of a.

In some embodiments, in a case where only a subset of a vector a of coefficients is available and in a case where only a subset of MIMO channel ĥ′ needs to be estimated, MIMO channel ĥ′ is estimated according to:

$${\hat{h}}^{′} = U * {a}^{′} ;$$

where a′ is a subset of a vector a of coefficients and U′ is a subset of channel space basis matrix U.

In some embodiments, in a case where an augmentation part is changed, the receiver-MIMO-reference-signal-placement is updated as placement matrix P_{Rx_update}; accordingly, compact channel basis θ_{aug} and its left inverse are updated as follows:

$$\begin{matrix}{θ}_{aug} = {P}_{Rx\_update} * U \\ {θ}_{aug}^{- 1} = {( {θ}_{aug}^{H} * {θ}_{aug} )}^{- 1 *} {θ}_{aug}^{H} .\end{matrix}$$

In some embodiments, a transmission-placement-to-pattern-generation method is selected among a plurality of transmission-placement-to-pattern-generation methods.

In some embodiments, basic-to-transmission-placement-generation method is selected among basic-to-transmission-placement-generation methods.

In some embodiments, receiver-placement-to-pattern-generation method is selected among receiver-placement-to-pattern-generation methods.

In some embodiments, basic-to-receiver-placement-generation method is selected among basic-to-receiver-placement-generation methods, or transmission-to-receiver-placement-generation method is selected among transmission-to-receiver-placement-generation methods.

In some embodiments, a region to which transmitter device and receiver device belongs may contain a plurality of small regions; different regions may be overlapping or separated; transmitter device and receiver device may be associated to different regions.

In some embodiments, the method further comprises, before a MIMO transmission starts, a region to which transmitter device and receiver device are associated is decided; obtaining, by the transmitter device and receiver device, prior knowledge, transmission-MIMO-reference-signal-pattern, and receiver-MIMO-reference-signal-pattern associated to the region.

In some embodiments, prior knowledge may be directly represented by a channel space basis matrix U, or indirectly by a compact channel matrix θ_{aug} or its left inverse as follow:

$$\begin{matrix}{θ}_{aug} = {P}_{Rx} * U \\ {θ}_{aug}^{- 1} = {( {θ}_{aug}^{H} * {θ}_{aug} )}^{- 1 *} {θ}_{aug}^{H}\end{matrix}$$

where P_{Rx} is a placement matrix determined by the receiver-MIMO-reference-signal-placement; wherein compact channel matrix θ_{aug} or its left inverse may be informed explicitly or calculated from channel space basis matrix U and receiver-MIMO-reference-signal-placement.

In some embodiments, transmission-MIMO-reference-signal-pattern may be informed explicitly or generated from transmission-MIMO-reference-signal-placement in transmission-placement-to-pattern-generation method.

In some embodiments, transmission-MIMO-reference-signal-placement may be informed explicitly or generated from basic-MIMO-reference-signal-placement in basic-to-transmission-placement-generation method.

In some embodiments, receiver-MIMO-reference-signal-pattern may be informed explicitly or generated from receiver-MIMO-reference-signal-placement in receiver-placement-to-pattern-generation method.

In some embodiments, receiver-MIMO-reference-signal-placement may be informed explicitly or generated from basic-MIMO-reference-signal-placement in basic-to-receiver-placement-generation method.

In some embodiments, basic-MIMO-reference-signal-placement may be informed explicitly or calculated from prior knowledge represented by channel space basis matrix U according to: wherein r pivot positions obtained from the channel space basis matrix U^{H}, the r pivot positions corresponding to the basic-MIMO-reference-signal-placement, each defining a reference signal position in a MIMO channel space by a subcarrier, a transmitter antenna, and a receiver antenna, where U^{H} is the Hermitian transpose of U.

In some embodiments, an explicitly informed transmission-MIMO-reference-signal-placement may be represented by a combination of building reference signal placements; wherein the building reference signal placements are pre-defined and pre-stored.

In some embodiments, an explicitly informed receiver-MIMO-reference-signal-placement may be represented by a combination of building receiver reference signal placements; wherein the building receiver reference signal placements are pre-defined and pre-stored.

In some embodiments, feedback based on channel measurement on the reference signal positions determined by receiver-MIMO-reference-signal-placement may include channel measurement on the reference signal positions in a vector of y.

In some embodiments, feedback based on channel measurement on the reference signal positions determined by receiver-MIMO-reference-signal-placement may include a vector of coefficient a or subset of coefficient a′ according to:

$$a = {θ}_{aug}^{- 1} * y$$

where compact channel matrix θ_{aug} or its left inverse as follow:

$$\begin{matrix}{θ}_{aug} = {P}_{Rx}^{*} U \\ {θ}_{aug}^{- 1} = {( {θ}_{aug}^{H} * {θ}_{aug} )}^{- 1 *} {θ}_{aug}^{H}\end{matrix}$$

where P_{Rx} is a placement matrix determined by the receiver-MIMO-reference-signal-placement; wherein θ_{aug} and θ_{aug}⁻¹ can be either given or calculated from receiver-MIMO-reference-signal-placement and channel space basis matrix U.

In some embodiments, the method further comprises, after receiving feedback based on channel measurement on the reference signal positions that contains a vector of y: estimating, by the transmitter device, MIMO channel according to: a vector coefficients of a determined according to:

$$a = {θ}_{aug}^{- 1} * y$$

MIMO channel ĥ is estimated according to:

$$\hat{h} = U * a ;$$

where U is channel space basis matrix.

In some embodiments, the method further comprises, after receiving feedback based on channel measurement on the reference signal positions that contains a vector of y: estimating, by the transmitter device, a subset of MIMO channel according to: a vector a of coefficients determined according to:

$$a = {θ}_{aug}^{- 1} * y$$

subset of MIMO channel ĥ′ is estimated according to:

$${\hat{h}}^{′} = {U}^{′} * a ;$$

where U′ is a subset of channel space basis matrix U.

In some embodiments, the method further comprises, after receiving feedback based on channel measurement on the reference signal positions that contains a vector of coefficient a or a subset of a vector of coefficient a′: estimating, by the transmitter device, MIMO channel according to:
MIMO channel ĥ is estimated according to:

$$\hat{h} = U * a ; or \hat{h} = U * {a}^{′} ;$$

where U is channel space basis matrix.

In some embodiments, the method further comprises, after receiving feedback based on channel measurement on the reference signal positions that contains a vector of coefficient a or a subset of a vector of coefficient a′: estimating, by the transmitter device, subset MIMO channel according to: subset of MIMO channel ĥ′ is estimated according to:

$${\hat{h}}^{′} = {U}^{′} * a ; or {h}^{′} = {U}^{′} * {a}^{′} ;$$

where U′ is a subset of channel space basis matrix U.

In some embodiments, a channel training matrix A is updated by a plurality of new channel samples for each of a plurality of different regions; wherein new channel space basis matrix U, basic-MIMO-reference-signal-placement, transmission-MIMO-reference-signal-pattern, receiver-MIMO-reference-signal-pattern, and compact channel basis θ_{aug} or its left inverse of compact channel basis θ_{aug}⁻¹ for each of a plurality of different regions are updated: a channel basis matrix U based on a rank-reduced truncated singular value decomposition (SVD) of channel training matrix A according to:

SVD(A)=UΣV^{H}
where the SVD on the training matrix A is truncated by keeping the largest r singular values, wherein r is a defined rank, and the channel basis matrix U has size n-by-r; and compact channel matrix θ_{aug} or its left inverse as follow:

$$\begin{matrix}{θ}_{aug} = {P}_{Rx} * U \\ {θ}_{aug}^{- 1} = {( {θ}_{aug}^{H} * {θ}_{aug} )}^{- 1 *} {θ}_{aug}^{H}\end{matrix}$$

where P_{Rx} is a placement matrix determined by the receiver-MIMO-reference-signal-placement; transmitter device and receiver device are updated of new channel basis matrix U, basic-MIMO-reference-signal-placement, transmission-M IM O-reference-signal-pattern, receiver-MIMO-reference-signal-pattern.

In some embodiments, the transmitter device is a base station and the receiver is a user equipment (UE).

In some embodiments, the transmitter device is user equipment (UE) and the receiver is a base station.

In some embodiments, wherein the transmitter device comprises a processor and a memory; the memory coupled to the processor; and memory stores instructions; when the instructions executed, cause the processor to perform the steps of transmitter device.

In some embodiments, wherein the receiver device comprises a processor and a memory; the memory coupled to the processor; and memory stores instructions; when the instructions executed, cause the processor to perform the steps of receiver device.

According to another aspect of the present disclosure, there is provided a system, comprising a transmitter device and receiver device, wherein the transmitter devise is configured to perform steps carried out by transmitter device as described herein; and the receiver devise is configured to perform steps carried out by receiver device as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 is a flowchart of a method of channel measurement and feedback;

FIG. 6 illustrates reshaping of m channel measurements into channel training matrix A;

FIG. 7A shows an example of a rank-reduced SVD on channel training matrix A;

FIG. 7B shows an example of pivot position generation;

FIG. 7C shows an example of a transmission-MIMO-reference-signal-pattern design;

FIG. 8 is an illustration of an example of basic-MIMO-reference-signal-placement matrix P;

FIG. 9 is an illustration of an example of a receiver-MIMO-reference-signal-placement matrix P_{Rx};

FIG. 10 is an illustration of an example of the calculation of θ_{aug};

FIG. 11 is an illustration of an example of the calculation of y;

FIG. 12 is an illustration of an example of the calculation of ĥ;

FIG. 13A is an illustration of an example of collecting training data set;

FIG. 13B is an illustration of a transmission-MIMO-reference-signal-pattern and a receiver-MIMO-reference-signal-pattern for one example;

FIG. 13C is an illustration of a transmission-MIMO-reference-signal-pattern and a receiver-MIMO-reference-signal-pattern for another example.

### DETAILED DESCRIPTION OF ILLUSTRATIVE EMBODIMENTS

As noted above, heavy overhead in measuring and feeding back channel measurements in 6G MIMO channel space make it difficult and costly to estimate a MIMO channel by a uniform MIMO reference signal placement scheme as in 5G. A uniform MIMO reference-signal placement would occupy a great portion of time-frequency-code radio resources to transmit reference signals. Accordingly, if needed, a feedback about estimated MIMO channel would result in significant CSI overhead.

Therefore, it is unfeasible to adopt a uniform MIMO reference signal placement as in 5G for a 6G-MIMO channel estimation and feedback. A new placement scheme and a new feedback scheme to estimate and feedback 6G-MIMO channel must reduce the density of reference signals but maintain good performance of MIMO channel estimation.

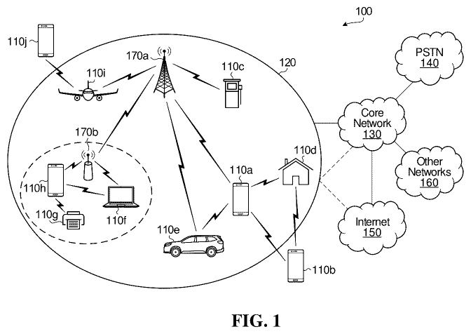

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

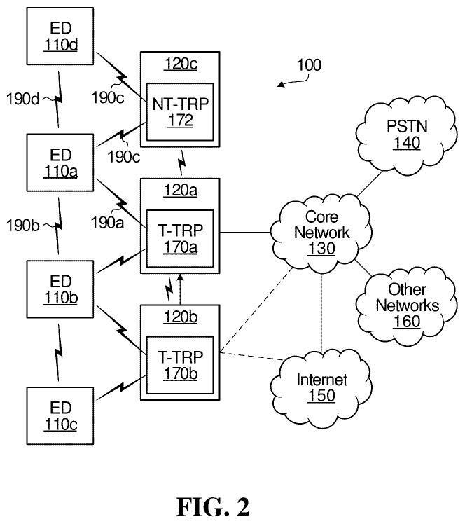

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some, or all, of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

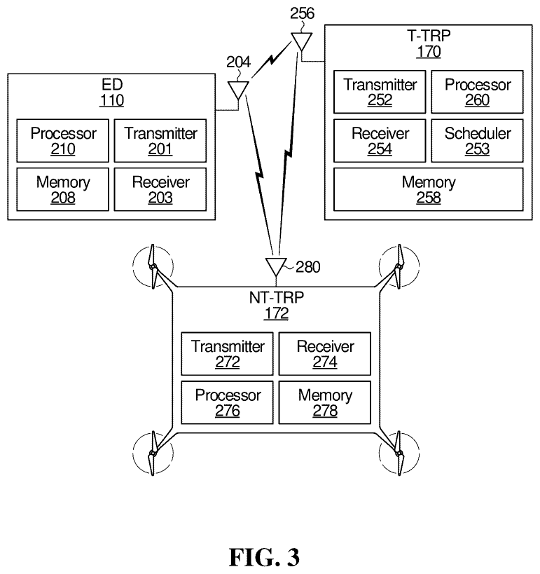

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

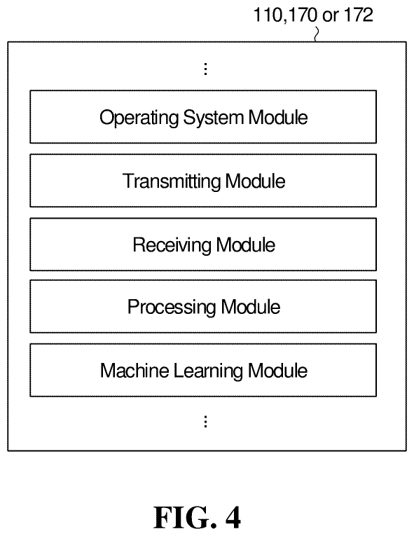

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

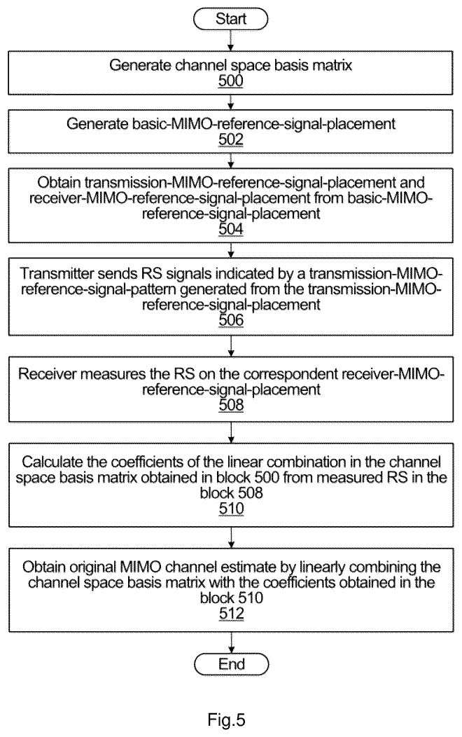

A method of MIMO channel estimation and feedback is provided. The method is introduced first with reference to FIG. 5, followed by a detailed description of example implementations of the method steps. Block 500 involves the generation of a channel space basis matrix. This can be achieved by collecting a number of ground-true or quasi-ground-true MIMO channel samples in a target region, vectorizing them, and juxtaposing them into a channel training matrix, each column of which is a vectorized MIMO channel sample. Note that, in this description, a column represents a vector. Alternatively, a vector can be represented by a row. Mathematically, both are equivalent to each other. In the following description, the column-wise representation is used. Channel space basis matrix can be obtained, made of the principal columns of the left singular matrix resulting from rank-reduced singular value decomposition (SVD) on the channel training matrix; then, any MIMO channel in the target region can be approximated by a linear combination of the columns of the channel space basis matrix. The principal columns of the left singular matrix, each of which is mathematically called a left singular vector, make a channel space basis. Therefore, the channel space basis matrix is orthonormal.

Next, in block 502, a basic-MIMO-reference-signal-placement is generated by calculating pivot columns on the Hermitian transpose of the channel space basis matrix obtained in block 500, for example as described in Applicant's co-pending patent application Ser. No. 92/012,665PCT01, hereby incorporated by reference in its entirety, which discloses a general methodology to find a sparse, non-uniform, and deterministic reference-signal-placement in a given high-dimensional signal space. In this application, we apply this methodology may be used to generate a sparse, non-uniform, and deterministic basic-MIMO-reference-signal-placement for a MIMO channel space

Next, in block 504, a transmission-MIMO-reference-signal-placement and receiver-MIMO-reference-signal-placement are obtained. A transmission-MIMO-reference-signal-placement indicates reference signal positions of a MIMO channel space on which subcarriers and on which transmitter antennas reference signals are to be transmitted. The corresponding receiver-MIMO-reference-signal-placement indicates reference signal positions of a MIMO channel space on which subcarriers and on which receiver antennas reference signals are to be received and then measured. In a MIMO transceiver embodiment, a receiver-MIMO-reference-signal-placement can include a basic part and an augmentation part. The basic part includes all the reference signal positions determined by a basic-MIMO-reference-signal-placement obtained in the second step 502. The augmentation part includes a plurality of additional reference signal positions, mostly because, in a MIMO transceiver, a signal from one transmitter antenna is naturally received by all receiver antennas. Therefore, one reference signal transmitted on a sub-carrier and from a transmitter antenna becomes a plurality of reference signals on the subcarrier and from the transmitter antenna but on different receiver antennas at the receiver device side. This is described in further detail below. In cases where the receiver device transmits a feedback to the transmitter device in order for the transmitter device to estimate MIMO channel, both the transmitter device and receiver device should know the same receiver-MIMO-reference-signal-placement being used. Therefore, before a MIMO transmission starts, both receiver device and transmitter device should align each other about the receiver-MIMO-reference-signal-placement. In a MIMO transceiver embodiment, a transmission-MIMO-reference-signal-placement is also determined by a basic-MIMO-reference-signal-placement by merging any two reference signal positions, in the basic-MIMO-reference-signal-placement, that share the same sub-carrier and the same transmitter antenna.

In block 506, the transmitter device transmits reference signals on the positions indicated by the transmission-MIMO-reference-signal-placement obtained at the third step 504. Moreover, besides the placement information, multiplexing scheme and transmitted signal values for each reference signal need to be specified and pre-defined before a MIMO transmission starts. A transmission-MIMO-reference-signal-pattern includes not only a transmission-MIMO-reference-signal-placement but also multiplexing scheme and transmitted signal value for each reference signal of the transmission-MIMO-reference-signal-placement. In block 508, the receiver device receives and then measures MIMO channel on the reference signals indicated by the receiver-MIMO-reference-signal-placement obtained in the third step 504. Moreover, besides placement information, the multiplexing scheme and reference signal values for each reference signal need to be decided. A receiver-MIMO-reference-signal-pattern includes a receiver-MIMO-reference-signal-placement, multiplexing scheme, and transmitted signal value for each reference signal of the receiver-MIMO-reference-signal-placement. In some cases, the receiver device may transmit a feedback based on channel measurement on the reference signals of the receiver-MIMO-reference-signal-placement to the transmitter device.

In block 510, the receiver device starts to use both channel measurement on the reference signals of the receiver-MIMO-reference-signal-placement and the prior knowledge represented by a channel space basis matrix. The receiver device measures channel on the reference signals according to the receiver-MIMO-reference-signal-pattern. The receiver device finds a vector of coefficients such that channel measurement on the reference signals can be a linear combination of the columns of the channel space basis matrix obtained in block 500 weighted by the vector of coefficients. Alternatively, a compact channel space basis matrix is employed, in which case, in this step, the receiver solves a determined or over-determined equation to find a vector of coefficients such that channel measurement on the reference-signal can be a linear combination of the columns of the channel space basis matrix obtained in block 500 weighted by the vector of coefficient. Details of the compact channel space basis matrix and example method of determining a compact channel space basis matrix are provided below.

In block 512, MIMO channel is estimated from a vector of coefficients obtained in the step 510 and channel space basis matrix by linearly combining the columns of the channel space basis matrix with a vector of coefficients obtained in the block 510.

The described approach includes steps performed by a transmitter device which can be viewed as a transmitter method, and steps performed by a receiver device which can be viewed as a receiver method. The steps be implemented in various scenarios. For example, either the BS or UE can initially send the reference signals, resulting in different procedure.

### Training Data Collection

Before this approach can be used to convey MIMO channel estimation, training data is collected or obtained. Training data collection involves collecting a sufficient number (m) of the MIMO channel samples in a high-dimensional MIMO channel space as channel training data set in a target region. For best results, MIMO channel samples randomly taken from a target region should cover typical conditions from the target region. In addition, m should be much larger than the rank of historical or empirical channel space basis. In a specific example, 5 times of rank of historical or empirical channel space basis can be considered as much larger.

All the MIMO channel samples in a channel training data set are in the same dimension or the same MIMO channel space; for example, the same set of subcarriers (L), the same number of transmitter antennas (M), and the same number of receiver antennas (N). Each channel MIMO channel sample is multiple-dimensional at least having three dimensions (L-by-N-by-M). It is noted that the provided method is open and easily applicable for an even higher dimensional MIMO signal space. For example, the timing (OFDM symbols or TTIs) can be considered as another dimension. For example, the coding (mask code) can be considered as another dimension. For simplicity of description, a three-dimensional MIMO channel space is used as an example in this disclosure. The benefit of this method is based on the prior knowledge assuming that there are some persistent and principal correlations in a MIMO channel space along timing, frequency, space, and/or code. The prior knowledge represented by channel space basis matrix is used to generate a sparse (low overhead) and non-uniform MIMO reference-signal placement but also to guarantee a good MIMO channel estimation performance.

All the MIMO channel samples in the channel training data set are collected from a target region covered by the same set of BS antennas. For example, the region can be a sector covered by BS or a subset of a sector. If the target region is covered by more than one set of BS antennas, each set of BS antennas will generate its own channel training data set. A channel training data set is associated to a region. Different channel training data sets are associated to different regions. Regions may be overlapped or separated physically. Accordingly, prior knowledge built from a channel training data set is associated to a region where the channel training data set is collected. Accordingly, a basic-MIMO-reference-signal-placement built from a prior knowledge is associated to a region to which the prior knowledge is associated. Accordingly, both transmission-MIMO-reference-signal-placement and receiver-MIMO-reference-signal-placement derived from a basic-MIMO-reference-signal-placement is associated to a region to which the basic-MIMO-reference-signal-placement is associated. It is also possible that a big region contains a plurality of sub-regions (smaller regions), in which, accordingly, the training data set can be divided into a plurality of sub data sets.

There are some strong and persistent spatial correlations hidden in a channel training data set because of the targeted region and its invariable environmental topology such as buildings. Then, these correlations, if learned from the channel training data set, are applicable to the target region, but also can be generalized for application to a target region and environment that is similar to where the channel training data set is obtained.

A channel training data set may be obtained from some real UEs or signal measurement equipment to randomly sample in the target region and certain environment; or, it can be accumulated from the real UE historic MIMO channel estimation in the target region and certain environment; or it can be synthesized by modeling the target region and certain environment in a simulator.

There may be different channel training data sets for the same target regions covered by different sets of BS antennas.

There may be different channel training data sets for different environments or environment-related scenarios for the same target region. For example, first channel training data set may be obtained for a heavy traffic scenario, e.g. daytime, and second channel training data set may be obtained for a light traffic scenario, e.g. night time. The first and second channel training data sets in this example are for the same target region, e.g. a particular street, covered by same set of BS antennas.

The channel training data set may be static, but it can be updated gradually, completely, or partially by new MIMO channel samples to follow time-varying changes in the targeted region and environment.

The channel training data set can be obtained with using MIMO precoder or without using MIMO precoder. But those with MIMO precoder and those without would be two different training data sets.

The channel training data set is used to acquire (i.e. learn) the commonality (strong and persistent spatial correlation) of a MIMO channel space in the targeted region.

### Produce Channel Training Matrix From Channel Measurement Data

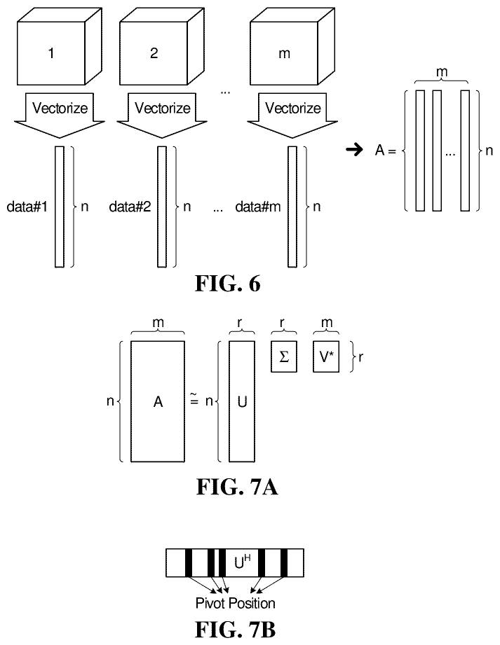

The m channel measurements are reshaped into a channel training matrix A. A reciprocal uplink and downlink channel assumption can be applied such that the same training matrix can be used for both uplink and downlink in TDD (Time Division Duplexing) mode. More specifically, each MIMO channel sample in MIMO three-dimensional channel space (L-by-N-by-M) is reshaped into a column-wise vector of size n-by-1, where n=L*M*N. The same reshaping protocol is kept for all the MIMO channel samples in the training data set. The reshaping protocol is reversible. In a specific example, if each value in the column-wise vector has a position given by #index, and each value in the MIMO three dimensional channel space has a position given by (#subcarrier index, #BS antenna index, #UE antenna index), the index in the column-wise vector can be related to the indices of the 3D form according to #index=#subcarrier index*(M*N)+#BS antenna index*N+#UE antenna index for each channel sample. The column-wise vectors are juxtaposed column by column to form a channel training matrix A, an n-by-m matrix, as shown in FIG. 6. The order of juxtaposition does not matter.

### Produce Channel Space Basis Matrix and Basic Reference Signal Placement Design

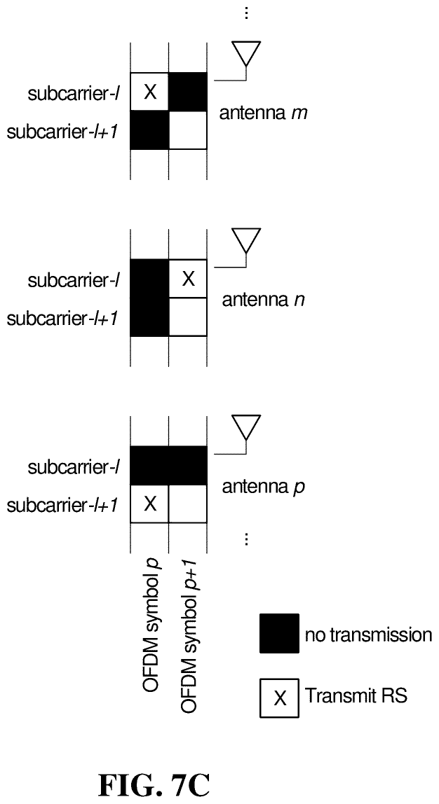

A channel training matrix A is then used as an input to generate a basic-MIMO-reference-signal-placement. This involves conducting a rank-reduced singular value decomposition (SVD) on the channel training matrix A by keeping r rank, SVD(A)=UΣV^{H}, where left singular matrix U is an n-by-r channel space basis matrix (orthonormal) that can (linearly) span the MIMO channel space in the target region. Channel space basis matrix U can represent prior knowledge of the target region. Rank r can be pre-defined empirically or decided in terms of the distribution of the resultant singular values. For example, only the singular values larger than a threshold may be preserved. The number of the preserved singular values is r. A rank-reduced SVD (A) example is shown in FIG. 7A.

For a large region, this can be divided into several small target regions. Each target region can be assigned a region ID to identify it in the system. These target regions may or may not overlap with each other. For each target region, there will be different channel training matrix A corresponding to different sets of BS antennas and different environment or environment-related scenarios. Each channel training matrix A can be assigned a channel training region ID. Generally speaking, a channel training matrix A is associated to a target region (a location). This channel training matrix A with its channel training region ID can be stored in a BS or other equipment (for example, a position sensing system).

In the case that the system decides to update a channel training matrix A, it can require a UE/UEs which is inside the target region corresponding to the channel training matrix A to measure the new MIMO channel samples. These new MIMO channel samples can be acquired by traditional channel estimation methods, for example, by sending densely placed, uniformly distributed MIMO reference signals and doing interpolation. Alternatively, or, in addition, MIMO channel samples may be obtained in a digital simulator which is synthesized by modeling the target region and a certain environment. These new channel measurements can be reported to BS or other equipment. The system will update the channel training matrix A by adding these new MIMO channel samples to the channel training matrix A or by replacing the oldest channel measurements inside channel training matrix A.

Each time the channel training matrix A is updated, the channel space basis matrix U which is generated from channel training matrix A needs to be recalculated and updated accordingly, either completely or partially.

Each channel training matrix A will be used to produce a corresponding channel space basis matrix U. Channel space basis matrix U is also associated to a target region. Therefore, each channel space basis matrix U derived from that channel training matrix A can be assigned the same and unique channel training region ID. Channel space basis matrix U with its channel training region ID can be stored together with channel training matrix A or stored in different place than channel training matrix A. Channel space basis matrix U with its channel training region ID can be stored in BS or other equipment (for example, a position sensing system). A UE may store many different channel space basis matrices U and their corresponding channel training region ID. These channel space basis matrices U can be sent to UE by BS or other equipment.

In the case that a communication needs to be established between a BS and a UE, which channel space basis matrix U to use may need to be decided first. Channel space basis matrix U may be selected based on the region to which UE belongs, set of BS antenna and different environment or environment-related scenarios. The location of the UE can be detected by the BS, or detected by other equipment (for example, a position sensing sensor in sensing system). When the location of UE is detected by BS, the BS can send the location information to the UE. When the location of the UE is detected by other equipment, the equipment can send the location information to the BS, or to the UE or to both the BS and the UE. Furthermore, different channel training matrix A and channel space basis matrix U associated to different regions can be stored in other equipment and can be sent to BS or UE when needed. The location of the UE can also be detected by the UE itself and the UE can report its location to the BS in the uplink.

In the case that location of the UE has been detected, the BS may decide which channel space basis matrix U to use together with other parameters and inform the UE of channel space basis matrix U in unicast, multicast and broadcast way in downlink.

In the case that a UE knows its own location, has a plurality of channel space basis matrix U stored, and has the knowledge on how to select channel space basis matrix U, the UE can decide on its own which channel space basis matrix U to use together with other parameters. Simultaneously, with the same UE's location information, the BS can make decision to select the same channel space basis matrix U and other parameters independently. This will save on controlling message transmission overhead before setting up MIMO communications between BS and UE.

In the case that the entire MIMO channel on all subcarriers between all transmitter and receiver antennas is not needed, but a subset of MIMO channel on some subcarriers between some transmitter and receiver antennas is needed, a subset U′ of U can be used instead of channel space basis matrix U. U is an n-by-r matrix and each row of U is correlated to the data of a subcarrier between a transmitter antenna and receiver antenna. U′ can be generated to consist of the rows of interest from U in some order. Channel space basis matrix U mentioned in above can be replaced with U′ in case the full U is not needed.

### Identify Pivot Columns

Identify r pivot columns on U^{H} (Hermitian of U, also equal to conjugate transpose of U). Alternatively, a reduced size U′, as introduced above, can be used in this step. Because the size of U^{H} is r-by-n, r pivot columns can be viewed as a basis to generate a columns space of U^{H}, The pivot columns can be also viewed as the columns that are most important in terms of characterization of the channel. An example is shown in FIG. 7B where certain columns of U^{H} are indicated to be pivot columns. In mathematics, there is no unique combination of r pivot columns. One method to identifying the pivot columns involves performing the following steps:
1. Take T=U^{H}.
2. Go through all columns of T one by one, find the column with largest two norm (also referred to as L2 norm, Euclidean norm) as a pivot column.
3. Take the pivot column vector generated from step 2, remove the projection on this pivot vector direction from each of the column vectors of T. Mark the new matrix produced in this manner as a new version of matrix T.
4. Repeat steps 2 and 3, until r pivot columns are found.

An alternative method to identify the pivot columns involves performing the following steps:
1. Take T=U^{H}.
2. Set i=1.
3. Go through all columns of T one by one, find the column with largest two norm, take this vector and mark as pᵢ.
4. Take vector pᵢ generated from step 3, calculate the cross correlation between this vector pᵢ with all the columns of T one by one. If the real part of cross correlation between pᵢ and a column of T is bigger than a predefined percentage threshold of autocorrelation of pᵢ, record this column vector into pivot column set i.
5. Calculate the average vector p_{i-avg} of the vectors in pivot column set i.
6. Take the average vector p_{i-avg} generated from step 5, remove the projection on this average vector direction from each of the column vectors of T. Mark the new matrix produced in this manner as a new version of matrix T.
7. Add 1 to i, i=i+1.
8. Repeat step 3-7, until i is bigger than r which means r pivot columns sets are found.
9. Randomly select or select following some rules one vector from each pivot columns set. These r vectors will form one combination of r pivot columns.
   By using the alternative method, many different combinations of r pivot columns can be obtained.

Besides the two listed methods, there are other alternatives to generate these r pivot columns. Because the combination of r pivot columns is not unique, it matters how to select the most suitable combination of pivot columns. Thus, the selection may depend on several criteria such as:
1. Performance of MIMO channel estimation: different combinations of pivot columns may lead to different channel estimation performances. Usually, the better performing combination is preferred.
2. Description Complexity: as the selection of these r pivot columns is not uniform, it may be easier to describe one combination than another one from the view of the specifications. In wireless systems, usually both transmitter and receiver should be informed of the combination of RS in the controlling messages. For example, a particular combination may be chosen based on the fact that it can be described in a more compact way than the others. For another example, where a transmitter or receiver has already recorded a combination of RS, the new combination of RS may be chosen based on a minimum update required comparing to the already recorded combination of RS.

Apparently, if the basic-MIMO-reference-signal-placement is calculated in both the transmitter device and receive device from the same channel space basis matrix U, the way to compute the pivot columns must be the same at both sides. Some indication or signalling is used to align the way to compute the pivot columns on both transmitter device and receiver device.

Thus, the combination of these r pivot columns may be selected as a function of the channel estimation performance and/or the description complexity. Each pivot column corresponds to a pivot position which can be indicated as a row index of U. According to the reshaping protocol, a pivot position indicates a specific subcarrier, between a specific transmitter antenna and a specific receiver antenna in the original three-dimensional MIMO channel space. There are r pivot positions.

Positions in a basic-MIMO-reference-signal-placement are generated based on the r pivot positions. Recall each pivot position in a vector is a one-to-one indicator of a position which indicates a specific subcarrier, a specific transmitter antenna and a specific receiver antenna in the original three-dimensional MIMO channel space. The r pivot positions are the basic-MIMO-reference-signal-placement.

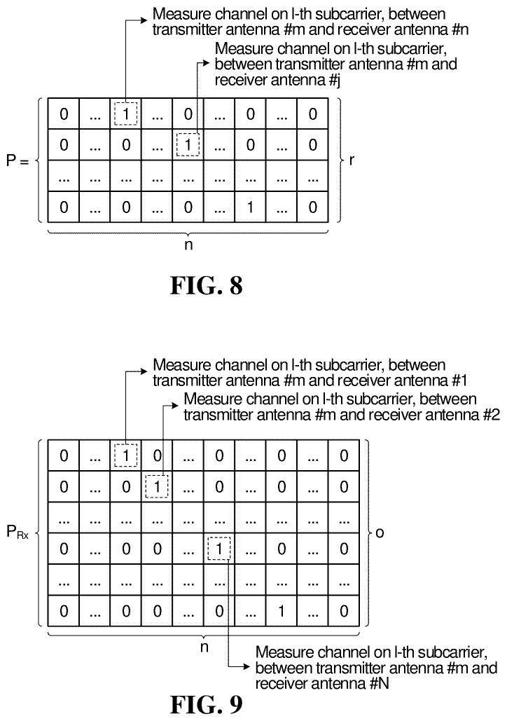

There are several ways to describe a basic-MIMO-reference-signal-placement. For instance, a basic-MIMO-reference-signal-placement is described in a table form. Alternatively, a basic-MIMO-reference-signal-placement is described in a placement matrix P, where P has n columns and r rows. The order of columns is the same as the order of rows in the associated channel space basis matrix U. Each row in P represents a pivot position, i.e. a reference signal position. Note that there is only one “1” in each row to indicate one basic reference-signal position. The column index of each “1” in each row indicates a specific subcarrier, between a specific transmitter antenna and a specific receiver antenna, as shown in FIG. 8.

In the case that the system generates a basic-MIMO-reference-signal-placement, and a UE requests this information, BS can transmit it to the UE in a unicast, multicast or broadcast transmission in downlink.

In some conditions, the system predefines a method to generate a basic-MIMO-reference-signal-placement from a channel space basis matrix U, when transmitter device and receiver device have the same channel space basis matrix U. In the same method, both can calculate the same basic-MIMO-reference-signal-placement separately and independently. In some conditions, the system may have a plurality of sets of reference-signal positions in a specification as building-reference-signal-placements. Each building-reference-signal-placement includes a plurality of reference signal positions which are indicated by subcarrier index, transmitter, and receiver antenna index. These indices can be absolute ones or relative ones; the latter being relative to some offset. A basic-MIMO-reference-signal-placement can be approximated by a combination of some building-reference-signal-placements. When both transmitter device and receiver device have all or a portion of building-reference-signal-placements, then a basic-MIMO-reference-signal-placement can be generated by combining some building-reference-signal-placements. Thus, only the information on how to combine building-reference-signal-placements to generate a basic-MIMO-reference-signal-placement is informed between a transmitter device and receiver device.

In a MIMO transceiver scheme, when a reference signal is transmitted from one transmitter antenna on one sub-carrier, the reference signal is received by all the receiver antennas on the sub-carrier. Then, a reference signal position in a basic-MIMO-reference-signal-placement indicating sub-carrier, transmitter antenna, and receiver antenna means differently for a transmitter device and a receiver device. A reference signal position in a transmission-MIMO-reference-signal-placement indicates sub-carrier, transmitter antenna. A reference signal position in a receiver-MIMO-reference-signal-placement indicates sub-carrier, transmitter antenna, and receiver antenna. From the same basic-MIMO-reference-signal-placement, a transmitter device generates a transmission-MIMO-reference-signal-placement, and a receiver device generates a receiver-MIMO-reference-signal-placement. Or a transmitter device generates a transmission-MIMO-reference-signal-placement from a basic-MIMO-reference-signal-placement and a receiver device generates a receiver-MIMO-reference-signal-placement from the transmission-MIMO-reference-signal-placement.

In some embodiments, further processing is done, starting with a basic-MIMO-reference-signal-placement, to generate a transmission-MIMO-reference-signal-placement for a transmitter device and receiver-MIMO-reference-signal-placement for a receiver device. Referring again to the specific example of FIG. 8, a basic-MIMO-reference-signal-placement represented by a placement matrix P in FIG. 8 indicates (among other channel measurements) a first reference signal transmitting and receiving on the l-th subcarrier, from the transmitter antenna #m to the receiver antenna #n, and also a second reference-signal transmission and receiving on the same subcarrier and same transmitter antenna and different receiver antenna #j (j≠m). However, the two reference signals collide over the air. As such, the transmission of the second reference signal symbol in this example is unnecessary and can be merged with the first reference signal. The transmitter device transmits one reference signal on the l-th subcarrier from the transmitter antenna #m. This reference signal position is included in the transmission-MIMO-reference-signal-placement. The receiver device receives two reference signals on the l-th subcarrier from receiver antenna #m and receiver antenna #j. Moreover, the receiver device can choose to receive more than the two reference signals on the l-th subcarrier on transmitter antenna #m up to from all the receiver antennas. This increases the number of the reference signals at the receiver device side, called as augmented reference signals. (Augmentation follows the mathematic term to describe the extension from determined equation to over-determined equation.) The augmented reference signals are included into the augmentation part in the receiver-MIMO-reference-signal-placement. In general, from a basic-MIMO-reference-signal-placement, a transmission-MIMO-reference-signal-placement results from merging any two reference-signal positions of the basic-MIMO-reference-signal-placement that share the same sub-carrier and the same transmitter antenna but different receiver antennas; and a receiver-MIMO-reference-signal-placement results from augmenting one reference-signal position of the basic-MIMO-reference-signal-placement into a plurality of reference-signal positions with the same sub-carrier and the same transmitter antenna but with different receiver antennas. Alternatively, a receiver-MIMO-reference-signal-placement results from augmenting one reference-signal position of the transmission-MIMO-reference-signal-placement into a plurality of reference-signal positions with the same sub-carrier and the same transmitter antenna but with different receiver antennas. For this reason, a basic-MIMO-reference-signal-placement, directly resulting from pivot columns, must be changed to a MIMO channel space, generating one transmission-MIMO-reference-signal-placement and one receiver-MIMO-reference-signal-placement.

Derived from the same basic-MIMO-reference-signal-placement represented by a placement matrix P, a transmission-MIMO-reference-signal-placement is represented by P_{TX} and a receiver-MIMO-reference-signal-placement is represented by P_{RX}. Besides a matrix form, they can also be represented in other forms such as tables.

Mathematically, a transmission-MIMO-reference-signal-placement (P_{TX}) is generated by merging any two reference-signal positions in a basic-MIMO-reference-signal-placement (P) whose subcarriers and transmitter antennas are the same but whose receiver antennas are different.

Besides a transmission-MIMO-reference-signal-placement generated from a basic-MIMO-reference-signal-placement, the system can define some complementary reference-signal positions in addition to the basic-MIMO-reference-signal-placement or transmission-MIMO-reference-signal-placement. Complementary reference signal positions may help enhance MIMO channel estimation performance and/or make it easier to describe a basic-MIMO-reference-signal-placement, transmission-MIMO-reference-signal-placement, and/or receiver-MIMO-reference-signal-placement.

In the case that the system generates a transmission-MIMO-reference-signal-placement and UE requests this information, BS can inform it to UE in a unicast, multicast or broadcast transmission in the downlink.

In some conditions, the system predefines a basic-to-transmission-placement-generation method to generate a transmission-MIMO-reference-signal-placement from a basic-MIMO-reference-signal-placement. Once transmitter device and receiver device have the same basic-MIMO-reference-signal-placement and each knows the same basic-to-transmission-placement-generation method, both can generate the same transmission-MIMO-reference-single-placement separately.

In some conditions, the system defines a plurality of basic-to-transmission-placement-generation methods, and a method to select one basic-to-transmission-placement-generation method under certain conditions. The system can also choose and apply one basic-to-transmission-placement-generation method during run time. In the case that reference-signals are transmitted by a UE as transmitter device, firstly the transmitter device needs to have basic-to-transmission-placement-generation methods that can be defined in specification and stored in the UE. The basic-to-transmission-placement-generation methods can also be sent to the UE, as transmitter device, from the BS, as receiver device, or other equipment. Secondly, the UE, as transmitter, needs to know which basic-to-transmission-placement-generation method to use for the following transmission. This can be chosen by the UE, as transmitter device, based on the method of how to select one basic-to-transmission-placement-generation method, as previously specified. Basic-to-transmission-placement-generation method can be also chosen by the BS, as receiver device, that sends the chosen basic-to-transmission-placement-generation method to the UE, as transmitter device. The method of how to select one basic-to-transmission-placement-generation method to use can also be sent to the UE, as transmitter device, from the BS, as receiver device, or other equipment for the UE, as transmitter device, can choose a basic-to-transmission-placement-generation method based upon which it can generate a transmission-MIMO-reference-signal-placement from a basic-MIMO-reference-signal-placement.

In order to generate a transmission-MIMO-reference-signal-placement from a chosen basic-to-transmission-placement-generation method, basic-MIMO-reference-signal-placement or channel space basis matrix U is needed.

In some conditions, the system may define sets of reference-signal positions in a specification as building reference signal placements. Each placement includes some reference signal positions which are indicated by subcarrier index, transmitter antenna index. These indexes can be absolute ones or relative ones to some offset which can be defined later. A transmission-MIMO-reference-signal-placement can be represented by combining some building reference signal placements. Both a transmitter device and a receiver device have all or a part of these building reference signal placements stored. After a transmission-MIMO-reference-signal-placement is generated, a combination of some sets of these reference-signal positions can be calculated to approximate to the transmission-MIMO-reference-signal-placement, as closely as possible. Then, instead of informing of transmission-MIMO-reference-signal-placement, only information relevant to how to synthesize a transmission-MIMO-reference-signal-placement from the building reference signal placements is needed. In such a case, the UE, as transmitter device, the BS, as receiver device, can send indications of how and which building reference signal placements to synthesize a transmission-MIMO-reference-signal-placement in unicast, multicast or broadcast transmission in the downlink.

When it is time to transmit reference signals, a transmission-MIMO-reference-signal-pattern is used by transmitter device to transmit reference signals onto real physical resources in a MIMO channel space. A transmission-MIMO-reference-signal-pattern not only indicates the transmitter device to transmit each reference signal on which subcarrier(s) over which transmitter antennas but also assigns which pre-defined transmitted signal value for each reference signal and in which multiplexing scheme such as OFDM symbol as timing multiplexing, or mask codes as coding multiplexing for each reference signal. A transmission-MIMO-reference-signal-pattern includes not only transmission-MIMO-reference-signal-placement but also transmitted signal value and multiplexing scheme for each reference signal in transmission-MIMO-reference-signal-placement.

A generic example of a transmission-MIMO-reference-signal-pattern is shown in FIG. 7C. A transmission-MIMO-reference-signal-pattern includes some multiplexing schemes to avoid reference signal collision over the air. In the example of FIG. 7C, a transmission-MIMO-reference-signal-placement requests the first reference signal transmitted on subcarrier-l on the transmitter antenna #m, the second reference signal on subcarrier-l on the transmitter antenna #n, and the third reference signal on the subcarrier-(l+1) on the transmitter antenna #p. There is resource conflict between the first reference signal and the second reference signal on subcarrier-l for antenna #m and antenna #n. To resolve this, a transmission-MIMO-reference-signal-pattern may apply a timing multiplexing scheme for both the first and second reference signals: the first OFDM symbol transmits the first reference signal on the subcarrier-l and on the transmitter antenna m, and the second OFDM symbol transmits the second reference signal on the subcarrier-l and on the transmitter antenna n. The multiplexing scheme in a transmission-MIMO-reference-signal-pattern may include frequency-multiplexing, time-multiplexing, code-multiplex and so on. In the case that the system generates a transmission-MIMO-reference-signal-pattern and UE needs this information, BS can send it to UE in unicast, multicast or broadcast way in the downlink.

In some conditions, the system can predefine a transmission-placement-to-pattern-generation method to generate a transmission-MIMO-reference-signal-pattern from a transmission-MIMO-reference-signal-placement. In this case, once transmitter device and receiver device have the same transmission-MIMO-reference-signal-placement and the same transmission-placement-to-pattern-generation method, they can produce the same transmission-MIMO-reference-signal-pattern separately.

The system can define a plurality of transmission-placement-to-pattern-generation methods, and a method to select which transmission-placement-to-pattern-generation method to use under certain conditions. A transmission-placement-to-pattern-generation method defines the transmitted signal value and multiplexing scheme for each reference signal in a transmission-MIMO-reference-signal-placement based on such parameters as user ID, antenna index, transmission comb number, cyclic shift, and so on. The system can also choose which transmission-placement-to-pattern-generation method to use during run time. These transmission-placement-to-pattern-generation methods can be stored in BS and UE. In the case that reference signals are transmitted by UE as transmitter device, UE needs to have a transmission-MIMO-reference-signal-pattern. The UE may generate the transmission-MIMO-reference-signal-pattern by assigning transmitted signal value and multiplexing scheme for each position in the transmission-MIMO-reference-signal-placement according to a chosen transmission-placement-to-pattern-generation method. How UE obtains a transmission-MIMO-reference-signal-placement is described in the previous sections. As for a chosen transmission-placement-to-pattern-generation method, UE may have stored a plurality of transmission-placement-to-pattern-generation methods and a method to select which transmission-placement-to-pattern-generation method to use. For example, a plurality of transmission-placement-to-pattern-generation methods and a method to select which transmission-placement-to-pattern-generation method to use can be defined in a specification. UE can generate a transmission-MIMO-reference-signal-pattern based on a method to select which transmission-placement-to-pattern-generation method to use according to the current condition. In the case that a transmission-placement-to-pattern-generation method to use is selected, both a transmitter device can use the transmission-placement-to-pattern-generation method to generate a transmission-MIMO-reference-signal-pattern from a transmission-MIMO-reference-signal-placement.

All the receiver antennas of a receiver device can receive the reference signals transmitted from one transmitter antenna on a sub-carrier. For a reference signal transmitted on the subcarrier, the receiver may choose to measure channel on all the receiver antennas or a subset of the receiver antennas. For an entire MIMO channel space, which receiver antenna(s) are chosen by the receiver device for measuring channel are include into a receiver-MIMO-reference-signal-placement according to a transmission-MIMO-reference-signal-placement or a basic-MIMO-reference-signal-placement. Denote the total number of all the chosen reference signals by a receiver device as o. A reference signal, by a receiver device, is transmitted from one transmitter antenna to one receiver antenna on a subcarrier; a reference signal, by a transmitter device, is transmitted from one transmitter antenna on a subcarrier.

A receiver-MIMO-reference-signal-placement must include at least basic-MIMO-reference-signal-placement, because MIMO channel estimation would make use of channel space basis matrix U. The number of reference signals in the basic-MIMO-reference-signal-placement is r. Basic-MIMO-reference-signal-placement is the minimum set of reference signals for a receiver device to estimate MIMO channel. Since all the receive antennas can receive the reference signals transmitted from one transmitter antenna on one subcarrier, it is up for a receiver device to take the received signal on more receiver antennas from the transmitter antenna on the subcarrier to measure channel. Thus, the receiver device would choose to o reference signals no less than r. Mathematically, in doing so (o>r), receiver device augments a determined equation into an over-determined one so that MIMO channel estimation performance is enhanced.

An augmentation method to increase the number of reference signals from r to o at a receiver device side:
1. When a transmitter device transmits a reference signal from one transmitter antenna on a subcarrier, a receiver device can receive the signals from all the receiver antennas on the subcarrier. The receiver device can choose to treat all or a subset of the received signals as its reference signals.
2. When a receiver antenna is required to measure a reference signal on a specific subcarrier indicated by the basic-MIMO-reference-signal-placement, it can, as a bonus, be required to measure on the other subcarriers in the same OFDM symbol where other reference signals have been transmitted. The chosen reference signals must include all the positions in the basic-MIMO-reference-signal-placement, otherwise it becomes underdetermined equation.

Receiver-MIMO-reference-signal-placement can be divided into basic part that includes all the reference signal positions in the basic-MIMO-reference-signal-placement and an augmentation part that include extra chosen reference signals.

When a receiver device measures the channel on the reference signals defined by the basic-MIMO-reference-signal-placement, only the minimum MIMO channel estimation performance is ensured. When a receiver starts to measure the reference signals in the augmentation part, the MIMO channel estimation performance may be enhanced. The receiver-MIMO-reference-signal-placement can be represented as a placement matrix P_{Rx}, more generally a matrix with n columns and o rows, and in the similar description form as placement matrix P of the basic-MIMO-reference-signal-placement. The order of columns is the same as order of rows in channel space basis matrix U. Each row in P_{Rx} represents a reference signal on which channel is measured. The column index of “1” in each row indicates to measure reference signal on specific subcarrier between specific transmitter antenna and specific receiver antenna. An example of P_{Rx} is shown in FIG. 9.

In the case that a receiver device may change the augmentation part of receiver-MIMO-reference-signal-placement, P_{Rx} needs to be updated by the receiver device to P_{Rx-update} by deleting the rows of column index “1” whose corresponding reference signals wouldn't be used and/or adding the rows of column index “1” whose corresponding reference signals would be used. Note that the basic part of receiver-MIMO-reference-signal-placement must remain.

The receiver-MIMO-reference-signal-placement can also be represented in table form.

In the case that the system generates a receiver-MIMO-reference-signal-placement and UE needs this information, BS can send it to UE in a unicast, multicast or broadcast transmission in the downlink.

In some conditions, the system can predefine a basic-to-receiver-placement-generation method to generate a receiver-MIMO-reference-signal-placement from basic-MIMO-reference-signal-placement. In this case, once transmitter device and receiver device have the same basic-MIMO-reference-signal-placement, they can produce the same receiver-MIMO-reference-signal-placement separately.

In some conditions, the system can predefine a transmission-to-receiver-placement-generation method to generate receiver-MIMO-reference-signal-placement from transmission-MIMO-reference-signal-placement. In this case, once transmitter device and receiver have the same transmission-MIMO-reference-signal-placement, they can produce the same receiver-MIMO-reference-signal-placement separately.

In some conditions, a receiver device may generate a receiver-MIMO-reference-signal-placement from a transmission-MIMO-reference-signal-placement, taking into account its own factors. For example, a receiver device can generate a receiver-MIMO-reference-signal-placement that includes only the basic part. Or receiver device can generate a receiver-MIMO-reference-signal-placement that includes both the basic part and augmentation part. If the receiver device needs to feedback the channel measurements on the reference signals in the receiver-MIMO-reference-signal-placement to a transmitter device, the transmitter device needs to know the receiver-MIMO-reference-signal-placement to estimate MIMO channel. The receiver device needs to inform the transmitter device of the receiver-MIMO-reference-signal-placement before the MIMO transmission starts.

In some conditions, a basic-to-receiver-placement-generation method can be defined to generate receiver-MIMO-reference-signal-placement from basic-MIMO-reference-signal-HWC placement. The system can define a plurality of basic-to-receiver-placement-generation methods, and/or a method of how to select which basic-to-receiver-placement-generation method to use under certain conditions. The system can also decide which basic-to-receiver-placement-generation method to use during run time. In the case reference signals are received by UE as receiver device, UE needs to have a receiver-MIMO-reference-signal-placement. UE may generate this receiver-MIMO-reference-signal-placement from basic-MIMO-reference-signal-placement and chosen basic-to-receiver-placement-generation method. How UE can get basic-MIMO-reference-signal-placement has been described in previous sections. As for a basic-to-receiver-placement-generation method, UE may have basic-to-receiver-placement-generation methods, and a method of how to select which basic-to-receiver-placement-generation method to use stored as defined in a specification. UE can generate a receiver-MIMO-reference-signal-placement based on these stored information and basic-to-receiver-placement-generation methods with reference to the current condition. In a case in which basic-to-receiver-placement-generation method to use is decided by the system, UE may have this information transmitted to it from BS or other network-side equipment.

In some conditions, a transmission-to-receiver-placement-generation method can be defined to generate receiver-MIMO-reference-signal-placement from transmission-MIMO-reference-signal-placement. The system can define a plurality of transmission-to-receiver-placement-generation methods, and a method of how to select which transmission-to-receiver-placement-generation method to use under certain conditions. The system can also decide which transmission-to-receiver-placement-generation method to use during the run time. In the case reference signals are received by UE as receiver device, UE needs to have receiver-MIMO-reference-signal-placement. UE may generate theses receiver-MIMO-reference-signal-placement from transmission-MIMO-reference-signal-placement and a transmission-to-receiver-placement-generation method. How UE can get transmission-MIMO-reference-signal-placement has been described in the previous sections. As for a transmission-to-receiver-placement-generation method, UE may have defined a plurality transmission-to-receiver-placement-generation methods, and a method of how to select which transmission-to-receiver-placement-generation method to use stored as defined in specification. UE can generate receiver-MIMO-reference-signal-placement based on these stored information and methods with reference to the current condition. In the case which transmission-to-receiver-placement-generation method to use is decided by the system, UE may have this information transmitted to it from BS or other network-side equipment. In one example, one transmission-to-receiver-placement-generation method defined by the system can be described as measuring on all receiver antennas.

In some conditions, the system may define a plurality of sets of receiver reference signal positions in specification as building receiver reference signal placements. Each placement includes some reference signal positions which are indicated by subcarrier index, receiver antenna index. (A building reference signal placement is for transmission includes some reference signal positions which are indicated by subcarrier index, transmitter antenna index.) These indices can be absolute ones or relative ones to some offset which can be defined later. The receiver-MIMO-reference-signal-placement can be represented by combining building receiver reference signal placements. Both BS and UE will have all or a part of building receiver reference signal placements stored. Once receiver-MIMO-reference-signal-placement is generated, a combination of some building receiver reference signal placements can be calculated to approximate receiver-MIMO-reference-signal-placement as close as possible. A number of other complementary reference signal positions can be included when choosing how to combine some sets of building receiver reference signal placements. A new receiver-MIMO-reference-signal-placement can be a combination of building receiver reference signal placements. In the case UE, as receiver device, measures channel on the reference signals, the BS, as transmitter, can send indications of which building receiver reference signal placements build up the receiver-MIMO-reference-signal placement in a unicast, multicast or broadcast transmission in the downlink.

When it is time to measure channel on the reference signal, a receiver-MIMO-reference-signal-pattern includes receiver-MIMO-reference-signal-placement, transmitted signal value, and (de)multiplexing scheme for each reference signal. For example, a reference signal transmitted on a specific subcarrier, between a specific transmitter antenna and a specific receiver antenna is described in the transmission-MIMO-reference-signal-pattern as on which subcarrier and which OFDM symbol and which signal value this reference signal is transmitted. Accordingly, the corresponding receiver-MIMO-reference-signal-pattern can be derived from the transmission-MIMO-reference-signal-pattern to indicate which receiver antenna and which OFDM symbol to measure the reference signals.

In the case that the system generates receiver-MIMO-reference-signal-pattern and UE needs this information, BS can send it to UE in unicast, multicast or broadcast way in the downlink.

In some conditions, the receiver can use a defined receiver-placement-to-pattern-generation method to generate a receiver-MIMO-reference-signal-pattern from receiver-MIMO-reference-signal-placement. This receiver-placement-to-pattern-generation method may refer to transmitted signal value and (de)multiplexing scheme for each reference signal in the receiver-MIMO-reference-signal-placement. How to get receiver-MIMO-reference-signal-placement has been introduced in previous sections.

In some conditions, the receiver can generate a receiver-MIMO-reference-signal-pattern from a transmission-MIMO-reference-signal-pattern and receiver-MIMO-reference-signal-placement. The principle of this method of generation has been described in previous sections. How to get a transmission-MIMO-reference-signal-pattern and receiver-MIMO-reference-signal-placement has also been introduced in previous sections.

In some conditions, the system can define a plurality of receiver-placement-to-pattern-generation methods, and a method of how to select which receiver-placement-to-pattern-generation method to use under certain condition. A receiver-placement-to-pattern-generation method can define transmitted signal value and de-multiplexing scheme for each reference signal in a receiver-MIMO-reference-signal-placement based on the parameters such as UE ID, antenna index, transmission comb number, cyclic shift, etc. The system can also decide which receiver-placement-to-pattern-generation method to use during the run time. These receiver-placement-to-pattern-generation methods can be stored in BS and UE. In cases in which reference signals are received by UE as receiver device, UE needs to have a receiver-MIMO-reference-signal-pattern. UE may generate this receiver-MIMO-reference-signal-pattern from receiver-MIMO-reference-signal-placement in a receiver-placement-to-pattern-generation method. How UE can get receiver-MIMO-reference-signal-placement has been described in the previous sections. As for a receiver-placement-to-pattern-generation method, UE may have defined a plurality of receiver-placement-to-pattern-generation methods, and a method of how to select which receiver-placement-to-pattern-generation method to use may be stored and/or defined in a specification. UE can generate a receiver-MIMO-reference-signal-pattern based on this information according to the current condition. In the case where the choice of receiver-MIMO-reference-signal-pattern mapping protocol to use is decided by the system, UE may have this information transmitted to it from BS or other network-side equipment.

In some conditions, the system can pre-generate transceiver MIMO reference signal patterns parameters (such as transmission-MIMO-reference-signal-pattern, receiver-MIMO-reference-signal-pattern) for a target region or several target regions. BS and UE can have this information together with corresponding channel space basis matrix U and compact channel basis θ_{aug}(θ_{aug}⁻¹) stored. During MIMO transmission, BS and UE can select the corresponding RS parameters to use based on UE's location, i.e. in which target region the UE is located. In this way, the communication of RS placement between BS and UE can be saved.

### Compact Channel Basis

A compact channel basis can be produced, based on the channel basis matrix U, but only including elements for which channel measurement is to be performed. If the reference signals are sent by a BS, the compact channel basis can be determined as follows:
1. Generate receiver-MIMO-reference-signal-placement from basic-MIMO-reference-signal-placement as detailed above. The generated reference signal positions can be in table forms or in matrix form P_{Rx}. In the case that the receiver device changes more reference signals on the augmentation part of receiver-MIMO-reference-signal-placement, P_{Rx} needs to be updated accordingly to P_{Rx-update}.
2. Calculate compact channel basis θ_{aug} as following:

$${θ}_{aug} = {P}_{Rx} * U$$

Or in the case that the receiver device changes more reference signals on the augmentation part of receiver-MIMO-reference-signal-placement:

$${θ}_{aug} = {P}_{Rx - update} * U$$

3. The left inverse matrix of the compact channel basis θ_{aug} can be calculated as θ_{aug}⁻¹.

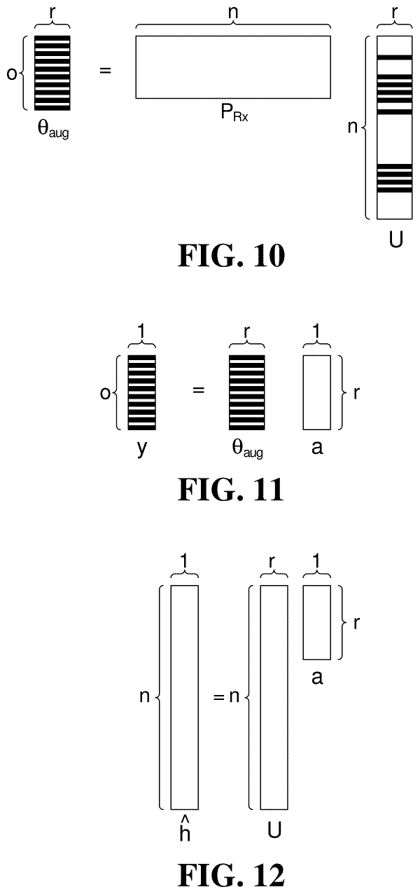

As shown in FIG. 10, θ_{aug} is o-by-r matrix. Since θ_{aug} is full column rank matrix and o is always equal or bigger than r, its left inverse matrix is unique and θ_{aug}⁻¹ is r-by-o matrix.

If the RS is sent by a UE, then the compact channel basis can be determined as follows:
1. Generate receiver-MIMO-reference-signal-placement from basic-MIMO-reference-signal-placement. The generated reference signal positions can be in table forms or in matrix form P_{Rx}. In the case that the BS changes the reference signals in the augmentation part of receiver-MIMO-reference-signal-placement, P_{Rx} needs to be updated accordingly to P_{Rx-update}.
2. Calculate compact channel basis θ_{aug} as following:

$${θ}_{aug} = {P}_{Rx} * U$$

or in the case that the BS changes the reference signals in the augmentation part of receiver-MIMO-reference-signal-placement

$${θ}_{aug} = {P}_{Rx - update} * U$$

3. Calculate left inverse matrix of compact channel basis θ_{aug} as θ_{aug}⁻¹.

In some conditions, some compact channel basis θ_{aug} and their left inverse matrix θ_{aug}⁻¹ related to a channel space basis matrix U can be calculated at the time that channel space basis matrix U is updated. These compact channel basis θ_{aug} and their left inverse matrix θ_{aug}⁻¹ can be stored together with the corresponding channel space basis matrix U.

In the case that a communication is to be established between a BS and a UE, and channel space basis matrix U and some basic parameters (such as receiver-MIMO-reference-signal-placement) have been defined, the associated compact channel basis θ_{aug} and/or its left inverse matrix θ_{aug}⁻¹ can be sent as needed to the BS, or UE, or both BS and UE.

Channel measurements can then be converted into a linear combination of the vectors of the compact channel basis, and in turn, the coefficients of the linear combination of vectors of the compact channel basis can be converted back into channel measurements. These steps can be taken at the transmitter device or receiver device in different implementations as detailed below.

To produce the linear combination of vectors of the compact channel basis, the following steps are performed:
1. The receiver device performs the channel measurements on the reference signal positions indicated by the receiver-MIMO-reference-signal-placement, and the estimated channel coefficients form a column-wise vector y of the channel measurements on the reference signals. y is o-by-1 vector. Each entry in y is a channel measurement on a position indicated by the receiver-MIMO-reference-signal-placement.
2. Based on y and θ_{aug} a linear combination vector a is determined as follows:

$$a = {θ}_{aug}^{- 1} * y$$

3. The receiver may choose not to measure on all the receiver-MIMO-reference-signal-placement, and size of y of the channel measurements on the reference signals is less than o-by-1. Meanwhile, θ_{aug} will also be updated to match the real measurement the receiver taken. For example, if there are only p RS measurements taken by receiver, the size of y will be p-by-1, and size of θ_{aug} will be r-by-p.

To estimate MIMO channel from the coefficients of the linear combination of vectors of the compact channel basis, it can also be seen that y can be considered as generated from θ_{aug}* a as shown in FIG. 11.

In the method disclosed in 92012665PCT01, the pivot columns taken from U form a full rank r-by-r square matrix θ. Since θ is full rank square matrix, its inverse matrix exists and is unique.

In the method of this disclosure, more receiver device antennas may be configured to measure and report reference signals sent by transmitter device. The set of receiver-MIMO-reference-signal-placement increases in size to o which is bigger than r. Under this condition, θ becomes θ_{aug}. θ_{aug} is tall thin, full column rank matrix. The left inverse matrix θ_{aug}⁻¹ of θ_{aug} exists and is unique.

With knowledge of a and U, approximated channel measurement on L subcarrier between BS and UE ĥ can be calculated as following, as shown in FIG. 12:

$$\hat{h} = U * a$$

In cases where the entire channel estimation (ĥ) is not estimated but a subset (ĥ′) of ĥ, a subset of U will likewise be relevant for calculation. Since the MIMO channel estimation (ĥ=U*a) is a linear operation, a subset of U, U′, instead of entire U is needed to be calculated, as indicated below. This would significantly reduce the computation complexity and memory if the subset (ĥ′) is much smaller than the entire ĥ:

$${\hat{h}}^{′} = {U}^{′} * a$$

In a first procedural option, the BS sends reference signals, and the UE reports y. The procedure is as follows:
i. Position of UE has been detected. Channel space basis matrix U with channel training region ID to use for current communication is decided as described in previous sections.
ii. The BS obtains the following information for a target region and environment: channel space basis matrix U, transmission-MIMO-reference-signal-placement and transmitter-MIMO-reference-signal-pattern. This information can be generated by the BS or transferred to the BS by other equipment. How to obtain or generate this information has been described in previous sections.
iii. The UE obtains the following information: receiver-MIMO-reference-signal-placement and receiver-MIMO-reference-signal-pattern. This information or information needed to generate this information can be sent to the UE by the BS or other equipment. For example, transmission-MIMO-reference-signal-pattern and receiver-MIMO-reference-signal-placement can be sent to UE to generate receiver-MIMO-reference-signal-pattern. The UE will generate a receiver-MIMO-reference-signal-pattern as described in previous sections. The UE may also decide on which augmented reference signal positions of receiver-MIMO-reference-signal-placement to do the channel measurement on the reference signals in the consideration of UE's own factors.
iv. The BS sends reference signals based on the transmission-MIMO-reference-signal-pattern.
V. The UE receives and measures channel on the reference signal positions indicated by receiver-MIMO-reference-signal-pattern to generate channel measurements on reference signal y.
vi. The UE reports y to BS. If the UE only measures a part of the reference signal positions indicated by receiver-MIMO-reference-signal-placement, UE also reports on which reference signal positions (receiver-MIMO-reference-signal-placement) it measured channel to BS.
vii. The BS receives y, and calculates compact channel basis θ_{aug}, a and ĥ. If UE only measures a part of the positions indicated by RS measurement positions, the BS will receive this information, and have to do the calculation of compact channel basis and a according to the real RS measurement the UE taken.

In a second procedural option, the UE sends RS. The procedure is as follows:
i. Position of UE has been detected. Channel space basis matrix U with channel training region ID to use for current communication is decided as described in previous sections.
ii. The BS obtains the following information for a target region and environment: channel space basis matrix U, compact channel basis θ_{aug}, receiver-MIMO-reference-signal-placement and receiver-MIMO-reference-signal-pattern. This information can be generated by the BS or transferred to the BS by other equipment. How to obtain or generate this information has been described in previous sections.
iii. The UE obtains the following information: transmission-MIMO-reference-signal-placement and transmission-MIMO-reference-signal-pattern. This information or information needed to generate this information can be sent to the UE by the BS or other equipment. For example, transmission-MIMO-reference-signal-placement can be sent to UE to generate a transmission-MIMO-reference-signal-pattern. How to obtain or generate this information has been described in previous sections.
iv. The UE sends RS.
V. The BS measures RS on positions indicated by receiver-MIMO-reference-signal-pattern or receiver-MIMO-reference-signal-placement information to generate y, and calculates a and ĥ. If BS only measures a part of the positions indicated by receiver-MIMO-reference-signal-placement, BS will have to do the calculation of compact channel basis and a according to the real RS measurements the BS has taken.

In a third procedural option, the BS sends RS, and the UE reports a or a subset of a. The procedure is as follows:
i. Position of UE has been detected. Channel space basis matrix U with channel training region ID to use for current communication is decided as described in previous sections.
ii. The BS obtains the following information for a target region and environment: channel basis matrix U, transmission-MIMO-reference-signal-placement and transmitter-MIMO-reference-signal-pattern. This information can be generated by the BS or transferred to the BS by other equipment. How to obtain or generate this information has been described in previous sections.
viii. The UE obtains the following information: receiver-MIMO-reference-signal-placement, receiver-MIMO-reference-signal-pattern and compact channel basis θ_{aug} or its left inverse θ_{aug}⁻¹. This information or information needed to generate this information can be sent to the UE by BS or other equipment. For example, the UE will generate receiver-MIMO-reference-signal-pattern based on transmission-MIMO-reference-signal-pattern and receiver-MIMO-reference-signal-placement. For another example, the UE will generate compact channel basis θ_{aug} from U and receiver-MIMO-reference-signal-placement. How to obtain or generate this information has been described in previous sections. The UE may also decide on which positions to do the channel measurement on the reference signals in the consideration of UE's calculation capacity or performance requirements. UE will update θ_{aug} or θ_{aug}⁻¹ according to the real RS measurements the UE has taken.
iii. The BS sends RS based on the transmission-MIMO-reference-signal-pattern.
iv. The UE receives and measures RS on positions indicated by the receiver-MIMO-reference-signal-pattern and/or receiver-MIMO-reference-signal-placement information to generate channel measurements on RS y. the UE calculates a from y and θ_{aug}⁻¹.
v. The UE reports a to the BS.
vi. The BS receives a, and calculates ĥ.

In a fourth procedural option, the BS sends RS, and the UE reports a or a subset of a, both BS and UE can calculate the same ĥ independently. The procedure is as follows:
vii. Position of UE has been detected. Channel space basis matrix U with channel training region ID to use for current communication is decided as described in previous section.
viii. The BS obtains the following information for a target region and environment: channel basis matrix U, transmission-MIMO-reference-signal-placement and transmission-MIMO-reference-signal-pattern. This information can be generated by the BS or transferred to the BS by other equipment. How to obtain or generate this information has been described in previous sections.
ix. The UE obtains the following information: receiver-MIMO-reference-signal-placement, receiver-MIMO-reference-signal-pattern and channel space basis matrix U. This information or information needed to generate this information can be sent to the UE by BS or other equipment. For example, the UE will generate a receiver-MIMO-reference-signal-pattern based on a transmission-MIMO-reference-signal-pattern and receiver-MIMO-reference-signal-placement. For another example, the UE will generate compact channel basis θ_{aug} from U and receiver-MIMO-reference-signal-replacement. How to obtain or generate this information has been described in previous sections.
ix. The BS sends reference signals based on the transmission-MIMO-reference signal-pattern.
x. The UE receives and measures RS on the reference signal positions indicated by the receiver-MIMO-reference-signal-pattern and receiver-MIMO-reference-signal-placement information to generate channel measurements on RS y. The UE calculates a from y and θ_{aug}⁻¹. The UE calculates ĥ from a and U.
xi. The UE reports a or subset of a to the BS.
xii. The BS receives a, or subset of a, and calculates ĥ.

In a fifth procedural option, the UE sends RS, and the BS reports a or subset of a to UE, both BS and UE can calculate the same ĥ independently. The procedure is as follows:
i. Position of UE has been detected. Channel space basis matrix U with channel training region ID to use for current communication is decided as described in previous sections.
ii. The BS obtains the following information for a target region and environment: channel basis matrix U, compact channel basis θ_{aug}, receiver-MIMO-reference-signal-placement and receiver-MIMO-reference-signal-pattern. This information can be generated by the BS or transferred to the BS by other network-side equipment. How to obtain or generate this information has been described in previous sections.
iii. The UE obtains the following information: transmission-MIMO-reference-signal-placement, transmission-MIMO-reference-signal-pattern and channel space basis matrix U. This information or information needed to generate this information can be sent to the UE by the BS or other network-side equipment. For example, transmission-MIMO-reference-signal-placement can be sent to UE to generate a receiver-MIMO-reference-signal-pattern. How to obtain or generate this information has been described in previous sections.
iv. The UE sends reference signals.
V. The BS measures channel on the reference signal positions indicated by the receiver-MIMO-reference-signal-pattern and receiver-MIMO-reference-signal-placement information to generate y, and calculates a and ĥ. If BS only measures a part of the reference signal positions indicated by receiver-MIMO-reference-signal-placement, BS will have to do the calculation of compact channel basis and a according to the real RS measurement the BS taken.
vi. The BS sends a or a subset of a, to UE.
vii. The UE calculates ĥ from a and U.

In the case that the entire set of channel measurements on all subcarriers between all transmitter and receiver antennas is not needed, but a subset of channel measurements on some subcarriers between some transmitter and receiver antennas is needed, a subset U′ can be used instead of channel space basis matrix U. Channel space basis matrix U mentioned in previous sections can be replaced with U′in case U is not needed.

This application provides new methods to perform MIMO channel estimation for any dimension MIMO system, especially for extremely high dimensional T-MIMO system.

The traditional way to solve MIMO channel estimation is to transmit uniformly distributed reference signal placement known to both transmitter and receiver. When the receiver receives reference signals, it will compare the received signals with the known transmitted reference signals to measure the channel status on the positions of reference signals. For the positions where reference signals are not presented, there are many classic algorithms (for example interpolation algorithm) can be used to calculate channel status.

The provided method is different to the traditional channel estimation in at least the following aspects:
1. The provided method involves a training procedure (not deep learning based on Stochastic Gradient). Channel measurements in the target are obtained region before setting up reference signals.
2. Unlike 5G NR, where reference signals are uniformly and densely placed, the provided reference signal design may be extremely sparse and not uniform in time-frequency-code resources.
3. In the provided method, channel space basis matrix (U) is different for different target regions and environments. Any channel measurement in the target region and environment is a linear combination of channel space basis matrix (U). The RS is used to calculate the channel as a linear combination vector applied on channel space basis matrix U. In this sense, a good channel estimation performance is maintained because the prior knowledge represented by the channel space basis matrix U is involved into the channel estimation.
4. In 5G NR, pre-coding is used to reduce M antenna ports to M′ antenna ports in order to reduce complexity, while RS in the provided method is already extremely sparse and can work both with and without pre-coding.

### FIRST EXAMPLE

In this first example, the UE transmits the reference signals. The example begins with collecting training data.

### Collect Training Data

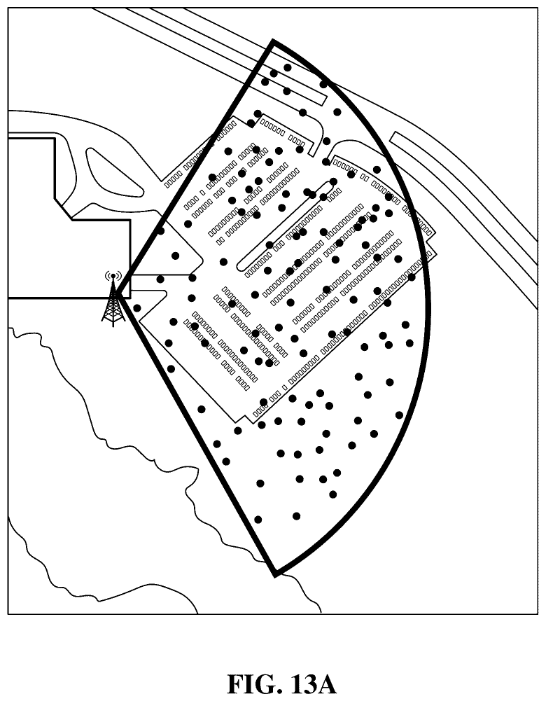

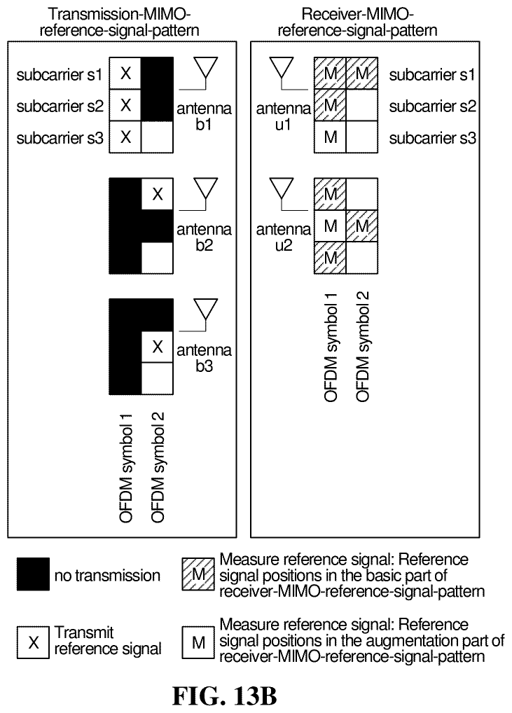

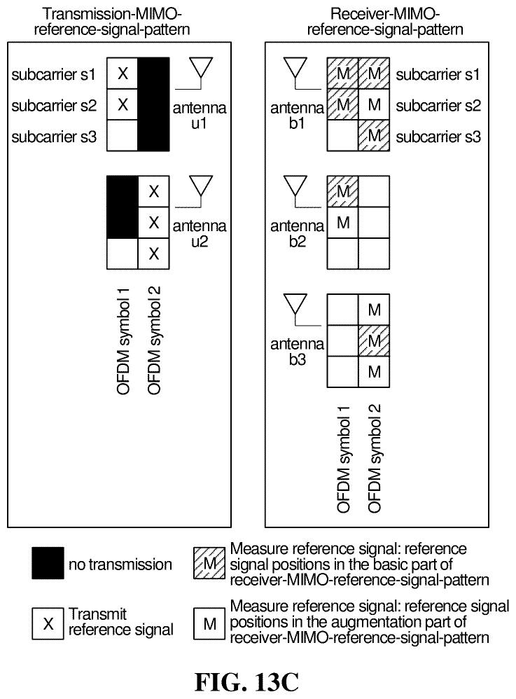

This involves, in a selected target region and environment, collecting m channel measurements. As an example shown in FIG. 13A, the target region is shown inside a solid frame. This region is covered by the same transceiver antennas of a BS. The dots within the coverage region represent m random positions. Channel measurements are measured at these m positions by using UEs or signal measurement equipment. All these channel measurements are taken under the same settings, for example, same set of subcarriers (L), same configuration of BS antennas, and same configuration of terminal antennas. Following the procedure introduced above, each channel measurement is vectorized and the measurements are combined into channel training matrix A, where the size of A is n-by-m with n=L*M*N. The m channel measurements can be collected by the BS or other network-side equipment which can communicate with the BS.

### Design Reference Signal

The calculations involved in this part can be taken place in the BS or other network-side equipment which can communicate with BS. In this example, the BS broadcasts RS to a UE. The following are generated: channel basis matrix, compact channel basis matrix, transmission-MIMO-reference-signal-placement, transmission-MIMO-reference-signal-pattern, receiver-MIMO-reference-signal-pattern and receiver-MIMO-reference-signal-placement before setting up MIMO communications.

Starting from channel training matrix A,
i. Define the rank r of A. Calculate singular values of A, and sort these singular values from largest to smallest. The number of singular values larger than a threshold is the rank of A. SVD on A is truncated by keeping the largest r singular values,

SVD(A)=UΣV^{H}
U is channel basis matrix, with size n-by-r.
ii. Generate r pivot positions of U^{H}. These r pivot positions are basic-MIMO-reference-signal-placement. Each entry of these r basic-MIMO-reference-signal-placement can be explained as a combination of a subcarrier, a BS antenna and an UE antenna.

An example of basic-MIMO-reference-signal-placement is shown in Table 1 below. For simplicity, for this example, there are 3 subcarriers (L=3), 3 transmitter antennas (M=3) and 2 receiver (N=2) antennas in the system, and r equals to 6. Each row represents a basic-MIMO-reference-signal-placement which was generated from pivoted columns on U^{H}.

TABLE 1
Example of basic-MIMO-reference-signal-placement

| Subcarrier index | transmitter antenna index | receiver antenna index |
|---|---|---|
| #s1 | #b1 | #u1 |
| #s1 | #b1 | #u2 |
| #s1 | #b2 | #u1 |
| #s2 | #b1 | #u1 |
| #s2 | #b3 | #u2 |
| #s3 | #b1 | #u2 |

iii. Generate transmission-MIMO-reference-signal-placement. This involves including each combination of subcarrier index and transmitter antenna index in the basic-MIMO-reference-signal-placement (as shown in Table 2a), and then deleting the repeated entries. Transmission-MIMO-reference-signal-placement can be in the form of a table as shown in Table 2b.

TABLE 2a
Example basic-MIMO-reference-signal-placement

| Subcarrier index | Transmitter antenna index |
|---|---|
| #s1 | #b1 |
| #s1 | #b1 |
| #s1 | #b2 |
| #s2 | #b1 |
| #s2 | #b3 |
| #s3 | #b1 |

TABLE 2b
Example for transmission-MIMO-reference-signal-placement

| Subcarrier index | transmitter antenna index |
|---|---|
| #s1 | #b1 |
| #s2 | #b1 |
| #s3 | #b1 |
| #s1 | #b2 |
| #s2 | #b3 |

iv. Design transmission-MIMO-reference-signal-pattern based on transmission-MIMO-reference-signal-placement. In a real MIMO system, there will be only one antenna active on one subcarrier during one time period to transmit reference signal. FIG. 13B shows an example of a transmission-MIMO-reference-signal-pattern and a receiver-MIMO-reference-signal-pattern. In order to solve the problem in the example, a transmission-MIMO-reference-signal-pattern can make use of time-multiplexing by using 2 consecutive OFDM symbols. In a specific example, the transmission-MIMO-reference-signal-pattern involves using antenna #b1 to send the 1^{st} OFDM symbol and transmit reference signals on subcarrier #s1, #s2 and #s3, during the first OFDM symbol, while there is no transmission on the subcarrier #s1, #s2 and #s3 from antenna #b2 and #b3. Using antenna #b2 to send the second OFDM symbol and put RS on subcarrier #s1 and using antenna #b3 to send the second OFDM symbol and put RS on subcarrier #s2, during 2nd OFDM symbol, while there is no transmission on subcarrier #s1 and #s2 from antenna #b1, no transmission on subcarrier #s2 from antenna #b2 and no transmission on subcarrier #s1 from antenna #b2. In the transmission-MIMO-reference-signal-pattern, the transmitted values for reference signals are also defined. Similar to the time-multiplexing, transmission-MIMO-reference-signal-pattern may adopt code-multiplexing scheme. For example, two reference signals can be transmitted on the same sub-carrier and the same transmitter antenna but with different mask codes.
v. Generate receiver-MIMO-reference-signal-placement. Receiver-MIMO-reference-signal-placement must include at least basic-MIMO-reference-signal-placement as basic part but can also include some augmented reference signals as augmentation part. For example, there are two augmented reference signal positions. The first augmented position is to use receiver antenna #u1 to measure reference signal on subcarrier #3 sent by transmitter antenna #b1. (Because receiver antenna #u1 is already set to measure the subcarrier #s1 and #s2 in the basic-MIMO-reference-signal-placement, it is an optional additional task for antenna #u1 to measure on subcarrier #s3.) The second augmented reference signal position is to use receiver antenna #u2 to measure reference signal on subcarrier #2 sent by transmitter antenna #b1. It is assumed that the receiver device has enough resources to do channel measurement on both basic and augmentation parts. The combinations of basic and augmented reference signal positions is shown in Table 3. The number of combinations of all reference signals is 8 (o equals 8). In order to calculate a compact channel basis, a receiver-MIMO-reference-signal-placement is represented by a placement matrix P_{Rx}. P_{Rx} is an o-by-L*M*N matrix with each row indicating a combination to do channel measurement on the reference signals.

TABLE 3
Example of receiver-MIMO-reference-signal-placement

| BS antenna index | Subcarrier index | UE antenna index |
|---|---|---|
| #b1 | #s1 | #u1 #u2 |
| #b1 | #s2 | |
| #b1 | #s3 | |
| #b2 | #s1 | #u1 |
| #b3 | #s2 | #u2 |

vi. Design receiver-MIMO-reference-signal-pattern based on transmission-MIMO-reference-signal-pattern. For example, in the receiver-MIMO-reference-signal-placement may indicate that channel measure reference signals should be transmitted on the subcarrier #s1 between BS antenna #b1 and UE antenna #u1 (<s1,b1,u1>) and #u2 (<s1,b1,u2>). With a given transmission-MIMO-reference-signal-pattern, antenna #b1 sends the first reference signal on the subcarrier #s1 in the 1^{st} OFDM symbol. Accordingly, the receiver antenna #u1 and #u2 can measure the first reference signal sent on the subcarrier #s1 in 1st OFDM symbol, as shown in FIG. 13B. In order to solve the example, a receiver-MIMO-reference-signal-pattern can be designed by measuring on 2 consecutive OFDM symbols. In a specific example, the receiver-MIMO-reference-signal-pattern involves using antenna #u1 to measure on subcarrier #s1, #s2 and #s3 on a first OFDM symbol, and to measure on subcarrier #s1 on a second OFDM symbol. Using antenna #u2 to measure on subcarrier #s1, #s2 and #s3 on the first OFDM symbol, and to measure on subcarrier #s2 on the second OFDM symbol. Calculate θ_{aug} and its left inverse.

$$\begin{matrix}{θ}_{aug} = {P}_{UEMeasure} * U \\ {θ}_{aug}^{- 1} = {( {θ}_{aug}^{H} * {θ}_{aug} )}^{- 1 *} {θ}_{aug}^{H}\end{matrix}$$

### Procedure

Having designed the reference signal as detailed above, the following is an example operational procedure:
i. The BS has the following information for a target region and environment: channel basis matrix U, transmission-MIMO-reference-signal-placement, transmission-MIMO-reference-signal-pattern, receiver-MIMO-reference-signal-placement. This information can be generated by BS or transferred to the BS by other network-side equipment.
ii. The BS broadcasts transmission-MIMO-reference-signal-pattern and receiver-MIMO-reference-signal-placement information in the downlink. The BS also broadcasts the reference signals based on the transmission-MIMO-reference-signal-pattern.
iii. The UE decodes RS transmission pattern and receiver-MIMO-reference-signal-placement information. The UE generates receiver-MIMO-reference-signal-pattern based on the transmission-MIMO-reference-signal-pattern and the receiver's channel measurement capacity. The UE receives and measures RS based on the indication given by receiver-MIMO-reference-signal-pattern.
iv. The UE feedbacks channel measurements on RS (y) in the uplink to BS.
v. The BS receive UE feedback of channel measurement on RS (y), generates corresponding θ_{aug} and θ_{aug}⁻¹, and calculates MIMO channel measurement between BS and UE(ĥ) as following:

$$\begin{matrix}a = {θ}_{aug}^{- 1} * y \\ \hat{h} = U * a\end{matrix}$$

### EXAMPLE 2

In this example, it is the UE that is transmitting the RS signal.

### Collect Training Data

This part will be the same as in the first example.

### Design Reference Signal

Same as example 1, the calculation involved in this part can be taken place in the BS or other network-side equipment which can communicate with the BS or the UE.

The same procedure as example 1 will be taken to generate channel basis matrix (U) and basic RS positions from channel training matrix A. for the sake of illustration, the same example with basic RS position as shown in Table 1 is also used here.
i. Generate transmission-MIMO-reference-signal-placement. Since a reference signal is transmitted by UE, first take the combinations of subcarrier index and UE antenna index in basic-MIMO-reference-signal-placement (as shown in Table 4a) and then delete the repeated entries. Transmission-MIMO-reference-signal-placement can be in the form of a table as shown in Table 4b.

TABLE 4a
Example for basic-MIMO-reference-signal-placement

| Subcarrier index | UE antenna index |
|---|---|
| #s1 | #u1 |
| #s1 | #u2 |
| #s1 | #u1 |
| #s2 | #u1 |
| #s2 | #u2 |
| #s3 | #u2 |

TABLE 4b
Example for transmission-MIMO-reference-signal-placement

| Subcarrier index | UE antenna index |
|---|---|
| #s1 | #u1 |
| #s2 | #u1 |
| #s1 | #u2 |
| #s2 | #u2 |
| #s3 | #u2 |

ii. Design a transmission-MIMO-reference-signal-pattern based on transmission-MIMO-reference-signal-placement. Although reference signal is sent by UE, the arrangement is made by network. The UE will be directed when and where to send the reference signal(s). There will be only one UE antenna active on one subcarrier during one time period to transmit a reference signal. In order to solve the example, a transmission-MIMO-reference-signal-pattern by using 2 consecutive OFDM symbols can be used as follows (shown in FIG. 13C): using antenna #u1 to send the first OFDM symbol and put RS on subcarrier #s1 and #s2, and there will be no transmission on subcarrier #s1 and #s2 from antenna #u2. Using antenna #u2 to send the second OFDM symbol and put RS on subcarrier #s1, #s2 and #s3, and there will be no transmission on subcarrier #s1, #s2 and #s3 from antenna #u1. In the transmission-MIMO-reference-signal-pattern, the reference signal values are also defined.
iii. Generate receiver-MIMO-reference-signal-placement. Receiver-MIMO-reference-signal-placement must include at least all the combinations in the basic-MIMO-reference-signal-placement as a basic part and some augmented reference signal positions as augmentation part. For example, there are 4 positions in the augmentation part. The reference signal positions in the augmentation part have been chosen with similar reasons as in the previous example. It is assumed that the receiver has enough resources and chooses to do the measurement on both the basic-MIMO-reference-signal-placement and the augmented reference signal positions. The combinations of basic positions and augmented reference signal positions is shown in Table 5. The number of reference signals is 10 (o equals 10). In order to calculate the compact channel basis, RS measurement position matrix P_{BSMeasure} is generated. P_{BSMeasure} is an o-by-L*M*N matrix with each row indicating a combination to do channel measurement on the reference signals.

TABLE 5
Example of receiver-MIMO-reference-signal-placement

| UE antenna index | Subcarrier index | BS antenna index |
|---|---|---|
| #u1 | #s1 | #b1 #b2 |
| #u1 | #s2 | |
| #u2 | #s1 | #b1 #b3 |
| #u2 | #s2 | |
| #u2 | #s3 | |

iv. Design receiver-MIMO-reference-signal-pattern based on transmission-MIMO-reference-signal-pattern and receiver's channel measurement factors. The design procedure is similar to that in the previous example. The receiver-MIMO-reference-signal-pattern solution for this example is depicted in FIG. 13C. Calculate θ_{aug} and its left inverse.

$$\begin{matrix}{θ}_{aug} = {P}_{BSMEasure} * U \\ {θ}_{aug}^{- 1} = {( {θ}_{aug}^{H *} {θ}_{aug} )}^{- 1 *} {θ}_{aug}^{H}\end{matrix}$$

### Procedure

Having designed the reference signal as detailed above, the following is an example operational procedure:
viii. The BS has the following information for a target region and environment: channel basis matrix U, transmission-MIMO-reference-signal-placement, transmission-MIMO-reference-signal-pattern, and receiver-MIMO-reference-signal-placement. This information can be generated by the BS or transfer to the BS by other network-side equipment.
ix. The BS broadcasts transmission-MIMO-reference-signal-pattern in the downlink.
X. The UE decodes the transmission-MIMO-reference-signal-pattern. Then the UE sends reference signals based on indication given by transmission-MIMO-reference-signal-pattern.
xi. The BS generates a receiver-MIMO-reference-signal-pattern based on the transmission-MIMO-reference-signal-pattern and the receiver's channel measurement factors. The BS also generates corresponding θ_{aug} and θ_{aug}⁻¹.
xii. The BS receives and measures reference signals to generate channel measurement on reference signal (y) based on indication given by receiver-MIMO-reference-signal-placement.
xiii. The BS calculates MIMO channel measurement between BS and UE (ĥ) as following:

$$\begin{matrix}a = {θ}_{aug}^{- 1} * y \\ \hat{h} = U * a\end{matrix}$$

### EXAMPLE 3

In this example, it is the BS that performs the reference signal transmission. Compared to the first example, the UE can further have information of the compact channel basis θ_{aug} or θ_{aug}⁻¹. With θ_{aug}⁻¹, the UE can calculate channel linear combination vector a and report a to BS in the uplink. Normally, the size of a is smaller than that of y, thus the reporting bandwidth is reduced compared to a situation where y is reported.

Compared to the first example, the only differences are in procedure part:
1. The BS has the following information for a target region and environment: channel basis matrix U, compact channel basis θ_{aug}, transmission-MIMO-reference-signal-placement, transmission-MIMO-reference-signal-pattern, receiver-MIMO-reference-signal-placement. This information can be generated by the BS or transferred to the BS by other network-side equipment.
2. The BS broadcasts the transmission-MIMO-reference-signal-pattern, receiver-MIMO-reference-signal-placement and compact channel basis θ_{aug} or θ_{aug}⁻¹ in the downlink.
3. The BS broadcasts RS based on the transmission-MIMO-reference-signal-pattern.
4. The UE decodes the transmission-MIMO-reference-signal-pattern, receiver-MIMO-reference-signal-placement and compact channel basis θ_{aug} or θ_{aug}⁻¹. The UE will generate the receiver-MIMO-reference-signal-pattern based on the transmission-MIMO-reference-signal-pattern and receiver-MIMO-reference-signal-placement. The UE receives and measures RS to generate channel measurement on reference signals (y) based on indication given by receiver-MIMO-reference-signal-pattern and receiver-MIMO-reference-signal-placement.
5. The UE calculates the channel as a linear combination vector a as following:

$$a = {θ}_{aug}^{- 1} * y$$

6. The UE reports channel linear combination vector (a) or subset of (a′) of a, in the uplink to BS.
7. The BS receives UE feedback of channel linear combination vector (a) or subset of (a′) of a and calculates MIMO channel between BS and UE (ĥ) as follows:

$$\hat{h} = U * a or \hat{h} = U * {a}^{′}$$

Numerous modifications and variations of the present disclosure are possible in light of the above teachings. It is therefore to be understood that within the scope of the appended claims, the disclosure may be practiced otherwise than as specifically described herein.

What is claimed is:

1. A communication method comprising:
receiving, by a receiver device, multiple input multiple output (MIMO) reference signals using a receiver-MIMO-reference-signal-pattern, wherein the receiver-MIMO-reference-signal-pattern comprises a receiver-MIMO-reference-signal-placement, the receiver-MIMO-reference-signal-placement is a non-uniform pattern of resources in space, time, frequency, or code, and the receiver-MIMO-reference-signal-placement is calculated based on a plurality of MIMO channel samples associated to a first region; and
estimating, by the receiver device, a MIMO channel from channel measurement on the reference signals and from the plurality of MIMO channel samples associated to the first region.

2. The method of claim 1, wherein the receiver-MIMO-reference-signal-placement being calculated based on the plurality of MIMO channel samples associated to the first region comprises that the receiver-MIMO-reference-signal-placement is calculated from pre-obtained data derived from the plurality of MIMO channel samples associated to the first region, wherein the pre-obtained data is represented by a channel space basis matrix U, the channel space basis matrix U consists of a plurality of orthonormal channel basis vectors and is obtained from a plurality of MIMO channel samples vectorized from a multiple-dimensional MIMO channel form including space, time, frequency, or code.

3. The method of claim 2, wherein the pre-obtained data represented by the channel space basis matrix U is associated to a second region, and different sets of pre-obtained data are represented by different channel space basis matrixes U and are associated to different second regions.

4. The method of claim 2, further comprising:
obtaining, by the receiver device, a third region to which a transmitter device and receiver device belong, the pre-obtained data represented by a channel space basis matrix U is associated to the third region, and a receiver-MIMO-reference-signal-pattern.

5. The method of claim 4, wherein the receiver-MIMO-reference-signal-pattern contains at least one of:
a receiver-MIMO-reference-signal-placement that includes reference signal positions, each of which indicates on which subcarrier, on which transmitter antenna, and on which receiver antennas in a MIMO channel space a reference signal is to be transmitted;
a transmitted signal value for each reference signal; or
a (de)multiplexing scheme for each reference signal.

6. The method of claim 1, further comprising:
obtaining, by the receiver device, the plurality of MIMO channel samples associated to the first region and the receiver-MIMO-reference-signal-pattern.

7. A communication method comprising:
transmitting, by a transmitter device, multiple input multiple output (MIMO) reference signals using a transmission-MIMO-reference-signal-pattern, wherein the transmission-MIMO-reference-signal-pattern comprises a transmission-MIMO-reference-signal-placement, wherein the transmission-MIMO-reference-signal-placement is a non-uniform pattern of resources in space, time, frequency, or code, and the transmission-MIMO-reference-signal-placement is calculated based on a plurality of MIMO channel samples associated to a first region.

8. The method of claim 7, wherein the transmission-MIMO-reference-signal-placement being calculated based on the plurality of MIMO channel samples associated to the first region comprises that the transmission-MIMO-reference-signal-placement is calculated from pre-obtained data derived from the plurality of MIMO channel samples associated to the first region, wherein the pre-obtained data is represented by a channel space basis matrix U, wherein the channel space basis matrix U consists of a plurality of orthonormal channel basis vectors and is obtained from a plurality of MIMO channel samples vectorized from a multiple-dimensional MIMO channel form including space, time, frequency, or code.

9. The method of claim 8, wherein the pre-obtained data represented by the channel space basis matrix U is associated to a second region, and different sets of pre-obtained data are represented by different channel space basis matrixes U associated to different second regions.

10. The method of claim 7, further comprising:
obtaining, by the transmitter device, the plurality of MIMO channel samples and the transmission-MIMO-reference-signal-pattern.

11. A device, comprising:
one or more processors, wherein when executing program instructions stored in the device, the device is caused to:
receive multiple input multiple output (MIMO) reference signals using a receiver-MIMO-reference-signal-pattern, wherein the receiver-MIMO-reference-signal-pattern comprises a receiver-MIMO-reference-signal-placement, wherein the receiver-MIMO-reference-signal-placement is a non-uniform pattern of resources in space, time, frequency, or code, and the receiver-MIMO-reference-signal-placement is calculated based on a plurality of MIMO channel samples associated to a first region; and
estimate a MIMO channel from channel measurement on the reference signals and from the plurality of MIMO channel samples associated to the first region.

12. The device of claim 11, wherein the receiver-MIMO-reference-signal-placement being calculated based on the plurality of MIMO channel samples associated to the first region comprises that the receiver-MIMO-reference-signal-placement is calculated from pre-obtained data derived from the plurality of MIMO channel samples associated to the first region, wherein the pre-obtained data is represented by a channel space basis matrix U, wherein the channel space basis matrix U consists of a plurality of orthonormal channel basis vectors and is obtained from a plurality of MIMO channel samples vectorized from a multiple-dimensional MIMO channel form including space, time, frequency, or code.

13. The device of claim 12, wherein the pre-obtained data represented by the channel space basis matrix U is associated to a second region, and different sets of pre-obtained data are represented by different channel space basis matrixes U associated to different second regions.

14. The device of claim 12, wherein when executing program instructions stored in the device, the device is further caused to:
obtain a third region to which a transmitter device and receiver device belong, a set of pre-obtained data represented by a channel space basis matrix U associated to the third region, and a receiver-MIMO-reference-signal-pattern.

15. The device of claim 14, wherein the receiver-MIMO-reference-signal-pattern contains at least one of:
a receiver-MIMO-reference-signal-placement including reference signal positions, each of which indicates on which subcarrier, on which transmitter antenna, and on which receiver antennas in a MIMO channel space a reference signal to be transmitted;
a transmitted signal value for each reference signal; or
a (de)multiplexing scheme for each reference signal.

16. The device of claim 11, wherein when executing program instructions stored in the device, the device is further caused to:
obtain the plurality of MIMO channel samples associated to the first region and the receiver-MIMO-reference-signal-pattern.

17. A device, comprising:
one or more processors, wherein when executing program instructions stored in the device, the device to is caused to:
transmit multiple input multiple output (MIMO) reference signals using a transmission-MIMO-reference-signal-pattern, wherein the transmission-MIMO-reference-signal-pattern comprises a transmission-MIMO-reference-signal-placement, wherein the transmission-MIMO-reference-signal-placement is a non-uniform pattern of resources in space, time, frequency, or code, and the transmission-MIMO-reference-signal-placement is calculated based on a plurality of MIMO channel samples associated to a first region.

18. The device of claim 17, the transmission-MIMO-reference-signal-placement being calculated based on the plurality of MIMO channel samples associated to the first region comprises that the transmission-MIMO-reference-signal-placement is calculated from pre-obtained data derived from the plurality of MIMO channel samples associated to the first region, wherein the pre-obtained data is represented by a channel space basis matrix U, and wherein the channel space basis matrix U consists of a plurality of orthonormal channel basis vectors and is obtained from a plurality of MIMO channel samples vectorized from a multiple-dimensional MIMO channel form including space, time, frequency, or code.

19. The device of claim 18, wherein the pre-obtained data represented by the channel space basis matrix U is associated to a second region, and different sets of prior obtained samples are represented by different channel space basis matrixes U associated to different second regions.

20. The device of claim 17, wherein when executing program instructions stored in the device, the device to is further caused to:
obtain the plurality of MIMO channel samples and the transmission-MIMO-reference-signal-pattern.
